(19) United States
(12) Patent Application Publication
(10) Pub. No.: US 2023/0249316 A1
(43) Pub. Date: Aug. 10, 2023

(54) ADAPTIVE ABRASIVE BLASTING

(71) Applicants: Rolls-Royce Corporation, Indianapolis, IN (US); Rolls-Royce North American Technologies, Inc., Indianapolis, IN (US); Virginia Tech Intellectual Properties, Inc., Blacksburg, VA (US)

(72) Inventors: Taylor K. Blair, Indianapolis, IN (US); Matthew R. Gold, Indianapolis, IN (US); Austin Scherbarth, Blacksburg, VA (US); Gary Pickrell, Denver, NC (US)

(21) Appl. No.: 17/650,011

(22) Filed: Feb. 4, 2022

(51) Int. Cl. B24C 7/00

(52) U.S. Cl. CPC B24C 7/0053

(57) ABSTRACT

Techniques for abrasively blasting (e.g., grit blasting) components, such as ceramic or CMC components. In some examples, based on a comparison of component geometry to a target geometry, a blasting path over the surface of the component may be generated for a selected traverse speed. A computing device may control a blasting device to blast the component according to the generated blasting path with the selected traverse speed. In some examples, based on a comparison of a component geometry to a target geometry, a respective traverse speed for a blasting device relative the component for each section of a plurality of sections over a surface of the component may be generated. A computing device controls the blasting device to blast the component according to the respective traverse speeds relative over a surface of the component to remove material from the surface of the component.

### TECHNICAL FIELD

The disclosure relates to techniques for modifying the surface of component, such as components used in gas turbine engines.

### BACKGROUND

The components of gas turbine engines operate in severe environments. For example, some components exposed to hot gases in commercial aeronautical engines may experience surface temperatures in excess of about 1200° C. At these extreme temperatures, component substrates may be exposed to environmental species such molten Calcium-Magnesium-Alumino-Silicate (CMAS) containing materials, which can cause chemical and/or mechanical damage to parts. Improving component resistance to molten CMAS has involved a focus on coating chemistry such as, for example, development of environmental barrier coatings (EBCs). Engine components may be coated with one or more barrier coatings to provide protection against thermal flux, erosion, and/or environmental contamination, for example, by reducing or preventing CMAS formation, migration, or infiltration. In some examples, the surface of the component substrates may be roughened for better adherence of subsequently deposited coatings.

### SUMMARY

The disclosure describes example techniques and systems for abrasively blasting (e.g., grit blasting) a component including, e.g., metallic, ceramic and CMC substrates. A blasting process may be employed to provide for a desired component geometry while also providing a desired surface roughness, e.g., to prepare the substrate surface for the deposition of one or more coatings such as a bond coat, an environmental barrier coating (EBC), thermal barrier coating, and/or abradable coating.

In some examples, the disclosure describes an example method comprising comparing, by a computing device, a geometry for a component to a target geometry for a blasted component, wherein the component comprises a metallic, a ceramic or ceramic matrix composite component; generating, by the computing device and based on the comparison, a respective traverse speed for a blasting device relative the component for each section of a plurality of sections of a surface of the component; and controlling, by the computing device, an abrasive blasting device to abrasively blast the component according to the respective traverse speeds relative the component generated for the plurality of sections of the surface of the component to remove material from the surface of the component.

In some examples, the disclosure describes an abrasive blasting system comprising: an abrasive blasting device configured to deliver an abrasive material to a surface of a component to blast a surface of the component with the abrasive material, wherein the component comprises a metallic, a ceramic or ceramic matrix composite component; and a computing device, wherein the computing device is configured to: compare a geometry for a component to a target geometry for a blasted component, wherein the component comprises a metallic, a ceramic or ceramic matrix composite component; generating, based on the comparison, a respective traverse speed for a blasting device relative the component for each section of a plurality of sections of a surface of the component; and controlling the abrasive blasting device to abrasively blast the component according to the respective traverse speeds relative the component generated for the plurality of sections of the surface of the component to remove material from the surface of the component.

In some examples, the disclosure describes a method comprising comparing, by a computing device, a geometry for a component to a target geometry for a blasted component, wherein the component comprises a metallic, a ceramic or ceramic matrix composite component; generating, by the computing device and based on the comparison, an abrasive blasting path over a surface of the component for a selected traverse speed; and controlling, by the computing device, an abrasive blasting device to abrasively blast the component with the generated abrasive blasting path to remove material from the surface of the component.

In some examples, the disclosure describes an abrasive blasting system comprising: abrasive blasting device configured to deliver an abrasive material to a surface of a component to blast a surface of the component with the abrasive material, wherein the component comprises a metallic, a ceramic or ceramic matrix composite component; and a computing device, wherein the computing device is configured to: compare a geometry for the component to a target geometry for a blasted component, wherein the component comprises a ceramic or ceramic matrix composite component; generate, based on the comparison, an abrasive blasting path over a surface of the component for a selected traverse speed; and control the abrasive blasting device to abrasively blast the component with the generated abrasive blasting path to remove material from the surface of the component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual and schematic diagram illustrating an example automated system for abrasive blasting of a component to roughen the surface of the component and modify the geometry of the component.

FIG. 1B is a conceptual diagram illustrating the abrasive blasting of a component using, e.g., the system shown in FIG. 1A.

FIG. 2 is a flow diagram illustrating an example technique for abrasively blasting a component in accordance with an example of the disclosure.

FIG. 3 is a conceptual diagram illustrating an example grit blasting process performed on a component in accordance with some examples of the disclosure.

FIG. 4 is a flow diagram illustrating another example technique for abrasively blasting a component in accordance with an example of the disclosure.

FIG. 5 is a flow diagram illustrating another example technique for abrasively blasting and then coating a component in accordance with an example of the disclosure.

FIG. 6 is conceptual diagram illustrating a process for identifying a desirable parameter value set to be used, e.g., in the technique of FIG. 5, based on the predicted outputs of each of a plurality of different parameter value sets.

FIG. 7-14 are various plots, images, and table related to testing carried out to evaluate some aspects of the disclosure.

FIGS. 15A and 15B are images showing the surface deviation of a component relative to a target geometry (FIG. 15A) and respective traverse speeds (FIG. 15B) generated for each discrete section of the surface to use in a grit blasting process with dynamically adjusted traverse speeds.

### DETAILED DESCRIPTION

The disclosure generally describes systems and techniques for roughening the surface of metallic, ceramic and/or CMC substrates (also referred to as parts or components), e.g., to prepare the component surface for the deposition of one or more coatings such as an environmental barrier coatings (EBCs). The component surface may be roughened using an abrasive blasting process, such as grit blasting. For ease of description, the techniques of the disclosure are described with regard to grit blasting as the abrasive blasting technique. However, it is contemplated that other abrasive blasting techniques such as sand blasting may be employed.

Grit blasting may be a necessary surface preparation step for thermal spray coatings for cleaning and roughening the surface. Grit blasting is frequently done manually but can be done robotically and generally the resultant roughness is the only process control output. With ceramic or ceramic matric composite parts (although also applicable to metallic parts) material removal becomes an important factor as tight tolerance stacks can be more difficult to achieve and grit blasting is more likely to remove material rather than deform it as with metals. Further with both metallic and ceramic parts that are to be coated, the coating is often relied upon to make up for deficiencies in the manufacturing capabilities that precede it.

Roughening a surface via grit blasting can enhance the coating adhesion for some types of plasma spray coatings. At the same time, grit blasting may have deleterious effects on the surface and mechanical properties of the substrate. In addition, grit blasting can remove a relatively large amount of material which may be undesirable, and this must be planned for when preparing a surface for coating. Reducing material removal and the effects on the surface/mechanical properties while creating a surface which promotes mechanical interlocking during thermal spray coating is ideal, however the knowledge of how to achieve these desired effects is lacking. This is especially true for the case of ceramics or CMCs components, which are of significant interest today.

In some examples, the present disclosure relates to the use of precise control of material removal for part dimension control of ceramic or CMC parts, e.g., used in high temperature mechanical systems such as gas turbine engines. Although the disclosure is primarily described with regard to ceramic or CMC parts, such examples may also apply to metallic part, such as superalloys. Tolerance stacks on parts may vary widely and can mean the difference between a relatively new technology (such as CMCs) adding value or not being financially feasible. There are not many ways to control part tolerances outside their manufacturing process, ultimately this may lead to applying coatings onto underlying part substrates extra thick in order to be machined to proper size. Additional machining of such parts is costly and time consuming. In some examples, part dimensions are generally already being measured after manufacturing, before coating so a desired amount of material removal form a grit blasting process may be determined and a traverse rate for the grit blasting process be calculated to produce the desired effect. This allows for tolerances to be improved on individual parts without additional processing steps and with minimal effect on subsequent coating operations.

In accordance with examples of the disclosure, system and techniques may be employed for more precise and efficient abrasively blasting (grit blasting) components, e.g., to prevent unnecessary material loss while providing for a blasted component with a desired geometry and surface roughness.

In some examples, an automated blasting process is employed in which a component geometry is measured (e.g., prior to blasting) and then compared to a target geometry of the component after being abrasively blasted, e.g., to roughen the surface prior to application of one more coatings onto the surface of the blasted component. In some examples, for a selected traverse speed during the blasting process, a blasting path for a grit plume or other particle stream to be followed by blasting device nozzle over the surface of the component may then be generated based on the comparison of the measure component geometry and target geometry. For example, for a selected traverse speed, a blasting path may be generated based on a target amount material to be removed from the component by the blasting process. The traverse speed may refer to the relative velocity between the component and plume of abrasive particle propelled by the blast nozzle as it moves relative to the component surface. During the blasting process, grit or other abrasive particles are propelled out of the nozzle towards the surface of the component, which may abrade the surface of the component to remove some portion of the component. The target amount of material to be removed by the blasting process may correspond to the amount of material to be removed from the measured component so that the component exhibits the target geometry (e.g., within some predefined variance) following the abrasive blasting process.

Such a process may employ relatively high traverse speed that is substantially constant during the blasting process while following the generated blasting path. As described further below, it has been found relatively low traverse speeds typically used in manual or automated grit blasting (e.g., less than 300 mm/s) result in substantial thickness loss for a ceramic or CMC component such as a reaction bonded SiC component. Utilizing the high traverse speed capability (600 mm/s to 2000 mm/s) of automated grit blasting may allow for substantial reduction in the component thickness loss with a small effect on the induced surface roughness. Additionally, higher traverse speeds may shorten the total blasting time required, allowing for more components to be blasted in the same amount of time and reducing the amount of grit used per part which reduces the costs associated with both.

Additionally, or alternatively, an automated blasting process may be employed in which a component geometry is measured (e.g., prior to blasting) and then compared to a target geometry of the component after being abrasively blasted, e.g., to roughen the surface prior to application of one more coatings onto the surface of the blasted component. Based on the comparison, a respective traverse speed may be generated for each position over all or a portion of the component surface, e.g., based on the amount of material to be removed at each spot by the blasting to achieve the target component geometry. The traverse speeds may be determined for a single pass of the grit plume over the surface of the component or for more than one pass of the grit plume over all or a portion of the component surface. Using such a technique, during the blasting of a component, the traverse speed may be dynamically adjusted moving over the surface of the component, e.g., based on the target amount of material to be removed.

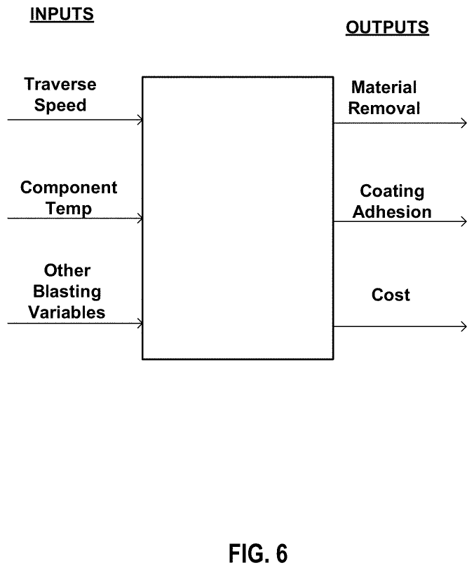

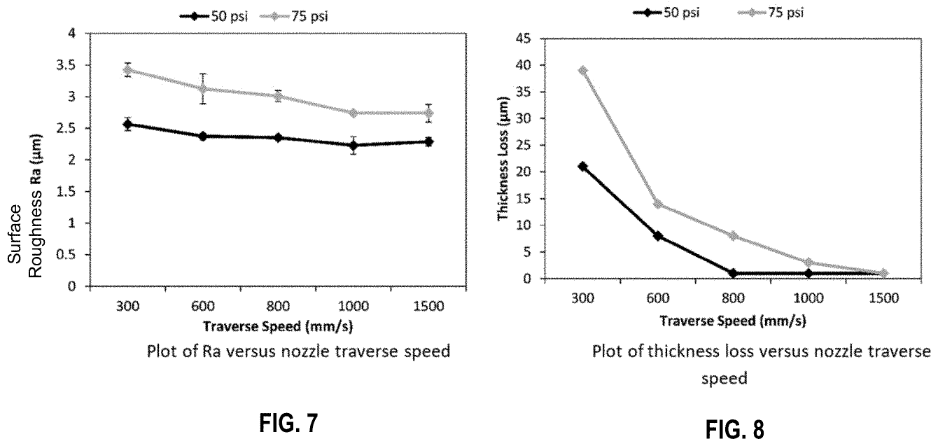

Techniques of the disclosure involve a blasting process in which a robotic abrasive blasting device maintains a relatively constant the traverse speed while moving the plume (stream of grit or other particles propelled out of the nozzle) over the surface of a component according to generated blast path. Additionally, or alternatively, example blasting techniques include dynamically controlling traverse velocity according to a blasting path during a blasting process with a robotically controlled blasting device, e.g., to control component part tolerances while roughening a surface of the component in preparation for a thermally sprayed coating onto the roughened surface of the component. As seen in FIGS. 7 and 8 (described in further detail below), during a grit blasting process, component material removal rate may be controlled almost entirely independently of the resulting surface roughness.

In some examples, the steps to implement simultaneous roughness and desirable material removal can encompass: 1) performing a GOM scan (or similar geometry measurement) of a part post manufacturing before grit blasting/coating and then compare the measured component geometry to a computer aided design (CAD) model (or other target geometry); 2) determine the surface heights on to-be-coated component surfaces relative to the CAD model (or other target geometry model); and 3) employ a model or other technique to identify traverse rates that will achieve the desired resultant part dimension in one or multiple grit blasting passes. In some examples, this process generates a multidimensional array of traverse rates and blasting positions. Each blasting position may correspond to a discrete section on a surface of the component, with the surface of the component being divided into discrete sections. On a flat component surface this may include three values: traverse speed (also referred to as traverse velocity), X-position, and Y-position (e.g., with a traverse rate value associate with each X, Y coordinate on the component surface). However, on a more complex three-dimensional surface this could include traverse speed, X-position, Y-position, Z-position, blasting nozzle vector, turntable position (e.g., the position of a moveable mount/stage holding the component), and/or the like). This generated array may be checked for spatial resolution (e.g., given the spot size of the grit plume) and movement/acceleration capabilities of the robotic blasting device. In some examples, an iterative process may be undertaken to find a total number of passes and local velocities that minimizes or otherwise reduce predicted variation from the desired target geometry of the blasted component. The process may also be iterative in that additional surface scans (or other measurements) may be incorporated after grit blasting that both step towards the desired geometry and refine the material removal rate model with each pass.

In some examples, before an abrasive blasting process, an entire batch of components may be measured to identify the respective differences between the measured geometries and target geometries. Using this information, an optimal engine set of these components and position of individual components within a system such as an engine may be identified to maximize or otherwise increase system (engine) performance (roundness, total dimensional stack, and/or the like). Such steps may consider the feasible dimensional changes from the abrasive blasting process as well as the tolerances on coating thickness control.

In some examples, the abrasive blasting process may further be controlled by varying the plume spot size to control the amount of surface area that is grit blasted in a single pass. This may be accomplished statically by selecting nozzles of smaller or larger diameter (or other nozzle opening size) or dynamically by controlling the blast pressure and/or distance, or by employing a variable diameter/outlet nozzle. A smaller spot size may allow for higher precision of material removal and more careful modification of component features (for example for blasting paths around cooling holes, optimizing for radii or leading edges) while a larger spot size can offer more efficiency, e.g., in terms of material rate.

Examples of the disclosure also include technique in which a component is abrasively blasted using one or more of the processes described herein and then subsequently coated with one or layers of material depositing using a thermal spray process. The deposited layers may form or part of an EBC, TBC, and/or abradable coating on the surface of the component. The component may be heated in combination (e.g., prior to and/or during) with the thermal spraying of the one or more layers of material. For example, a grit blasted component may be heated prior to the deposition of a coating material so that the temperature of the component surface is elevated when the coating material is deposited (e.g., via a thermal spray process) to form one or more coatings. The heating of the component may increase the adhesion of the coating. In some examples, a blasted component is mounted in the booth or other thermal spray enclosure, and the spray gun is used as a torch to heat the component surface and then apply the coating material. This preheating may be done before each layer is deposited, e.g., before each of a bond coat, EBC, and/or abradable layers.

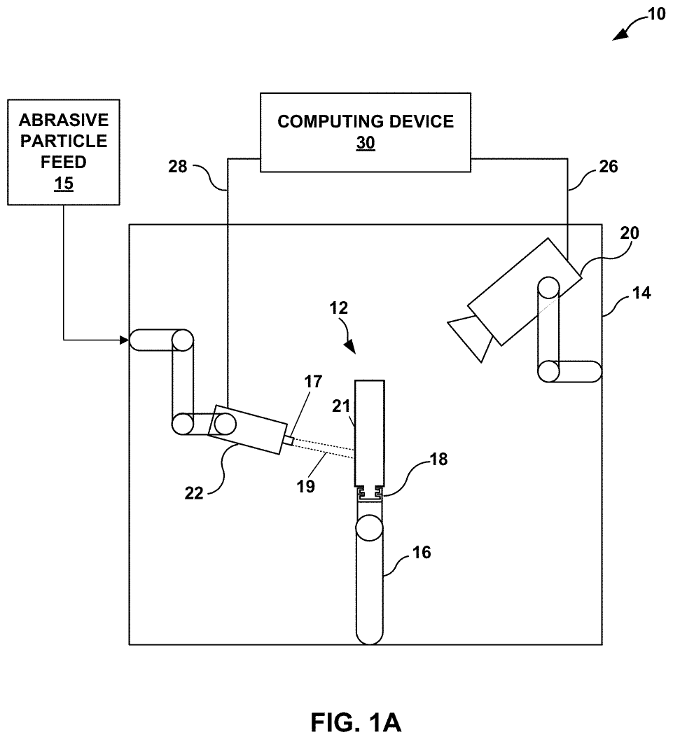

FIG. 1A is a conceptual and schematic block diagram illustrating an example system 10 for abrasively blasting component 12. As described herein, component 12 may be a ceramic or CMC substrate that is grit blasted using system 10 to roughen the surface ((increase the surface roughness) of component 12, e.g., prior to the deposition of one or more coatings onto the surface of component 12, such as, an EBC, thermal barrier coating, abrasive coating, and/or the like.

In some examples, component 12 may be a component of a high-temperature mechanical system, such as, for example, a gas turbine engine. Component 12 may ultimately be used as a blade track, an airfoil, a blade, a vane, a combustion chamber liner, or the like, of a gas turbine engine.

Component 12 may include a metallic (e.g., superalloy), a ceramic and/or CMC substrate. In some examples, component 12 may include a ceramic or a CMC that includes Si. In some examples, component 12 may include a silicon-based material, such as silicon-based ceramic or a silicon-based CMC.

In some examples in which component 12 includes a ceramic, the ceramic may be substantially homogeneous. In some examples, component 12 that includes a ceramic includes, for example, a Si-containing ceramic, such as SiO₂, silicon carbide (SiC) or silicon nitride (Si₃N₄); Al₂O₃; aluminosilicate (e.g., Al₂SiO₅); or the like.

In examples in which component 12 includes a CMC, component 12 may include a matrix material and a reinforcement material. The matrix material includes, e.g., a ceramic material, such as, SiC, Si₃N₄, Al₂O₃, aluminosilicate, SiO₂, or the like. The CMC may further include a continuous or discontinuous reinforcement material. For example, the reinforcement material may include discontinuous whiskers, platelets, or particulates. As other examples, the reinforcement material may include a continuous monofilament or multifilament weave. In some examples, the reinforcement material may include SiC, Si₃N₄, Al₂O₃, aluminosilicate, SiO₂, or the like. In some examples, component 12 includes a SiC—SiC ceramic matrix composite or an oxide-oxide CMC.

Component 12 may include a metallic material suitable for use in a high-temperature environment. In some examples, component 12 includes a superalloy including, for example, an alloy based on Ni, Co, Ni/Fe, or the like. In examples in which component 12 includes a superalloy material, component 12 may also include one or more additives such as titanium (Ti), cobalt (Co), or aluminum (Al), which may improve the mechanical properties of component 12 including, for example, toughness, hardness, temperature stability, corrosion resistance, oxidation resistance, or the like.

Although FIGS. 1A and 1B illustrates component 12 as defining a simple, substantially rectangular geometry, in other examples, component 12 may define a more complex geometry, including simple or complex curves, overhangs, undercuts, or the like.

System 10 may include an enclosure 14 defining a grit blasting station. System 10 also may include stage 16, mount 18, measuring device 20, and blasting device 22, all or a part of which may be disposed within enclosure 14. Abrasive particle feed 15 supplies blasting device 22 with abrasive particles that propelled out of nozzle 17 towards surface 21 of component 12 as particle plume 19 during a grit blasting process. In the case of grit blasting as the abrasive blasting technique, the abrasive particles may be referred to as grit.

Enclosure 14 may be any suitable size or shape to at least partially enclose component 12, stage 16, mount 18, measuring device 20, and blasting device 22. In some examples, enclosure 14 may be sized or shaped to allow an operator to insert or remove any one or more of component 12, stage 16, mount 18, measuring device 20, and blasting device 22 to and from enclosure 14. In some examples, enclosure 14 may be configured to maintain selected environment, e.g., a pressure or a gas composition different than atmospheric pressure or composition, around component 12. In some examples, enclosure 14 may include two or more enclosures. For example, a first enclosure may at least partially enclose at least measuring device 20, and a second enclosure may at least partially enclose at least blasting device 22. System 10 also may include computing device 30, which may control operation of system 10, including, for example, at least one of stage 16, measuring device 20, or blasting device 22.

Mount 18 may be configured to receive and detachably secure component 12, e.g., relative to measuring device 20 and blasting device 22. For example, mount 18 may be shaped to receive a root section (e.g., fir tree section) of a turbine blade. Mount 18 may further include a clamp (e.g., spring clamp, bolt clamp, vise, or the like) or another fastener configured to detachably secure component 12 on stage 16. In some examples, stage 16 and/or mount may be a turn table device or a multi-axis manipulator device in which component 12 may be mounted on during a blasting process. The turn table device or other multi-axis manipulator device may be repositionable/movable to allow for an increase the accessibility of areas of a component 12 during the blasting process, to help generate/control traverse speed during the grit blasting process, and/or otherwise provide additional component positioning parameters (component rotational velocity, angle, and/or the like).

Measuring device 20 may be configured to measure a three-dimensional surface geometry of component 12. For example, measuring device 20 may include a coordinate measuring machine (“CMM”) (e.g., the CMM probe may be mechanical, optical, laser, or the like), a structured-light three-dimensional scanner, another non-contacting optical measurement device; digital image correlation, photogrammetry, or the like. In some examples, measuring device 20 may measure a variation in the surface of component 12 with a precision that is less than about 50 microns, less than about 25 microns, or less than about 10 microns. In other examples, measuring device 20 may measure a variation in the surface of component 12 with a precision that is less than a predetermined threshold value (e.g., a tolerance of a geometry of component 12).

Measuring device 20 may generate a data set including a plurality of values that define the surface of component 12. For example, the data set may include a plurality of tuples, such as a plurality of 3-tuples, where each tuple defines a point on the surface of component. Measuring device 20 may generate the data set with any selected format readable by computing device 30.

Blasting device 22 may be configured to direct plume 19 of grit material out of nozzle 17 to surface 21 of component 12 to abrade or otherwise remove a surface portion of component 12. The grit blasting of component 12 may modify the properties of surface 21, e.g., by increasing the surface roughness of component 12 and/or decreasing the surface roughness of component 12. In some examples, blasting device 22 may be controlled by computing device 30 to propel grit towards a location of the surface of component 12 with a single pass or over multiple passes of the blasting device 22 over the location.

Computing device 30 may include, for example, a desktop computer, a laptop computer, a tablet computer, a workstation, a server, a mainframe, a cloud computing system, a robot controller, or the like. Computing device 30 is configured to control operation of system 10 including, for example, at least one of stage 16, mount 18, measuring device 20, or blasting device 22. Computing device 30 may be communicatively coupled to at least one of stage 16, mount 18, measuring device 20, or blasting device 22 using respective communication connections. In some examples, the communication connection may include a network link, such as Ethernet or other network connections. Such connection may be wireless connection, a wired connection, or a combination of both. In some examples, the communications connections may include other types of device connections, such as, USB, IEEE 1394, or the like. For example, computing device 30 may be communicatively coupled to measuring device 20 via wired or wireless measuring device connection 26 and/or blasting device 22 via wired or wireless coating device connection 28.

In some examples, to function as described herein, computing device 30 may include control circuitry, such as one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Although not shown in FIG. 1A, system 10 may include one or more power sources. In some examples, one or more power source may be electrically coupled to each of computing device 30, measuring device 20, and blasting device 22. In other examples, one or more power sources may be electrically coupled to computing device 30, which may be electrically coupled to each of measuring device 20 and blasting device 22 via measuring device connection 26 and coating device connection 28, respectively.

Computing device 30 may be configured to control an operation of any one or more of stage 16, mount 18, measuring device 20, or blasting device 22 to position component 12 relative to measuring device 20, blasting device 22, or both. For example, computing device 30 may control any one or more of stage 16, mount 18, or measuring device 20 to translate and/or rotate along at least one axis to position component 12 relative to measuring device 20. Positioning component 12 relative to measuring device 20 may include positioning at least a portion of component 12 to be measured using measuring device 20 relative to measuring device 20. Similarly, computing device 30 may control any one or more of stage 16, mount 18, or measuring device 20 to translate and/or rotate along at least one axis to position component 12 relative to blasting device 22. Positioning component 12 relative to blasting device 22 may include positioning at least a portion of component 12 to be blasted using blasting device 22 relative to blasting device 22.

Computing device 30 also may be configured to control an operation of blasting device 22. In some examples, computing device 30 may control the supply of abrasive particles or other media (e.g., grit) from feedstock 15 to blasting device 22. The abrasive material may include, for example, grit such as silicon carbide (SiC), aluminum oxide, silica, or boron carbide. Suitable SiC grit may be 220 with an average grit size of 63 micrometers; however, other sizes, grades and/or types are contemplated.

In some examples, computing device 30 may control blasting device 22 to propel grit, toward surface 21 of component 12. Blasting nozzle 17 may be used to concentrate and/or direct the grit propelled towards component 12 in the form of a stream of grit 19 also referred to as a grit plume 19. In some examples, the grit may be propelled by compressed/pressurized air with is directed in the path of the grit particle and through the nozzle 17. The velocity of grit within plume 19 may be controlled by computing device 30, e.g., by varying the pressure used to propel the grit of plume 19. In some example, nozzle 17 may have an adjustable outlet size which allows for the adjustment of the plume spot size on surface 21 of component 12. In other examples, the plume spot size on surface 21 may be varied by adjusting the distance of nozzle 17 from surface 21 of component 12 and/or switching out nozzle 17 with another nozzle having a different outlet size.

Computing device 30 may control blasting device 22 to direct the grit toward a surface of component 12, by controlling a position, orientation, and movement of blasting device 22 relative to component 12. Computing device 30 may control a position, orientation, and movement of blasting device 22 to direct the coating material toward one or more locations/sections on the surface of component 12.

FIG. 1B is a conceptual diagram illustrating an example of component 12 being grit blasted by blasting device 22 under the control of computing device 30 (not shown in FIG. 1B). In FIG. 1B, component 12 includes unblasted surface 21 and blasted surface 32. As shown, during a blasting process, blasting device 22 propels a stream of grit (referred to as grit plume 19) out of nozzle 17. Computing device 30 controls the relative motion of nozzle 17 relative to component 12. In the example of FIG. 1B, nozzle 17 moves in direction 34 which is in the Y-direction along the X-Y plane indicated in FIG. 1B. The relatively speed between nozzle 17 and component 12 defines the traverse speed of the blasting process. Plume 19 contacts surface 21 which causes the removal of a portion 36 of component 12, leaving blasted surface 32. Blasted surface 32 may have a surface roughness that is, e.g., greater than unblasted surface 21.

Computing device 30 may control the parameters that define the blasting process. Example parameters include the traverse speed, the blast angle (e.g., as defined by the angle of the outlet direction of nozzle 17 (or longitudinal axis of plume 19) relative to the surface plane of component 12), blast pressure (or other velocity of the grit propelled towards component 12), grit mass flow rate, standoff distance (e.g., distance between outlet of nozzle 17 and surface 21), and the like. Each of these parameters may influence the amount of material removed from component 21 during a blasting process (e.g., represented by portion 36) and the resulting surface roughness of blasted surface 32 of component 12.

Computing device 30 may be configured to control measuring device 20 to acquire a representation of the three-dimensional surface geometry (e.g., geometry) of component 12. For example, computing device 30 may control measuring device 20 to measure a geometry of component 12. The geometry of component 12 may include two or three-dimensional coordinates for a plurality of locations on component 12. In some examples, computing device 30 may control a mechanical or optical probe of measuring device 20 to scan or raster a surface of component 12 to acquire the geometry of component 12. In other examples, computing device 30 may control a plurality of optical elements of measuring device 20 to acquire a plurality of images of component 12. The plurality of images may be analyzed by computing device 30 or measuring device 20 to reconstruct the geometry of component 12. As discussed above, computing device 30 may be communicatively coupled to measuring device 20. In this way, computing device 30 may receive a geometry of component 12 from measuring device 20. Further, as described above, the geometry of component 12 may include a data set in any selected format, such as a plurality of tuples, representing the geometry of component 12.

In some examples, computing device 30 may be configured to control measuring device 20 to acquire respective geometries of each component of a plurality of components. For example, computing device 30 may control measuring device 20 to acquire a respective geometry of a plurality of geometries of a single component in a respective state of a plurality of states. Each state may be a different stage of a manufacturing process by which component 12 is formed. For example, a first state may be after casting, forging, additive manufacturing, or the like to form component 12, wherein component 12 has a surface 21 that has not been abrasively blasted. A second stage may be after an initial blasting of component 12 by blasting device 22 over all or a selected area of surface 12 of component 12. A third stage may be another blasting after the initial blasting of component 12 by blasting device 22 over all or a selected area of surface 12 of component 12. Other states are possible, depending on the manufacturing process used to form component 12. Also, computing device 30 may control measuring device 20 to acquire a respective geometry of a plurality of geometries of a respective component 12 of each component a plurality of components in a first state (e.g., an unblasted state, or a blasted state, or both). The plurality of components may be components with the same or substantially similar geometry, or dissimilar geometry.

For example, computing device 30 may receive, from measuring device 20, data representative of a geometry of component 12. The geometry of component 12 may include three-dimensional coordinates of a plurality of locations on surface 21 of component 12. In some examples, the geometry may include a respective geometry of component 12 in a respective state of a plurality of states. For example, the geometry may include a first geometry of component 12 that may be in the initial unblasted state. In other examples, the geometry may include a second geometry of component 12 in a second state following blasting of component 12 by device 22. In other examples, the geometry may include a respective geometry of component 12 in a respective state of a plurality of states (e.g., as discussed above). In some examples, computing device 30 may receive, from measuring device 20, data representative of a respective geometry of a plurality of geometries of a respective component 12 of a plurality of components each in a respective state of a plurality of states.

Once computing device 30 receives the data representative of the actual or present geometry of component 12, in some examples, computing device 30 may compare the measured geometry for each respective location of the plurality of locations of component 12 to a target component geometry. Based on the comparison, computing device 30 may determine a target amount of material to be removed from component 12 to provide for a blasted component that has a geometry substantially the same as the target geometry (e.g., with some selected variance). In some examples, the target component geometry may be a geometry of component 12 after component 12 is abrasively blasted, e.g., in preparation of the application of one or more coatings on the blasted surface. As described herein, the blasting of component 21 may modify, e.g., increase, the surface roughness (Ra) of component 12 to allow for better adhesion of subsequently applied coatings onto the rough surface.

For example, computing device 30 may determine, for each respective location of the plurality of locations (which represent points on the surface(s) of component 12 (e.g., a respective x-, y-, z-axis coordinate in a three-coordinate system)), an amount of material to be removed at each point based on a difference between a measured geometry and a target geometry. In some examples, to facilitate determining the difference between the measured geometry and the target geometry for each location, computing device 30 may register the measured geometry to the target geometry. For example, component 12 may include a geometrical registration feature that computing device 30 uses to register the measured geometry of component 12 to the target geometry. The registration feature may be a dedicated registration feature (e.g., a feature that serves no useful purpose aside from registration) or an incidental registration feature (e.g., a functional feature of component 12 that can also be used as a registration feature). The registration feature may include, for example, a predetermined size, shape, orientation, or the like, to allow computing device 30 to accurately register the measured geometry to the target geometry.

Computing device 30 may be configured to determine the respective difference for each respective location of the plurality of locations in a direction substantially normal to the measured surface of component 12 at the respective location. By determining the respective differences in a direction substantially normal to the measured surface of component 12, computing device 30 may facilitate the removal of a portion of component by blasting surface 21 to achieve the target geometry, as the blasting device 22 may be oriented to result in material being removed from surface 21 in a direction substantially normal to the surface of component 12.

After determining the plurality of respective differences, computing device 30 may determine a number of passes that plume 19 from blasting device 22 will travel over each section of a plurality of sections to remove the target amount of material at each location of component 12, a traverse rate that plume 17 of blasting device 22 will travel over each sections of the plurality of sections to remove the target amount of material from component 12 at each section of component 12, or both.

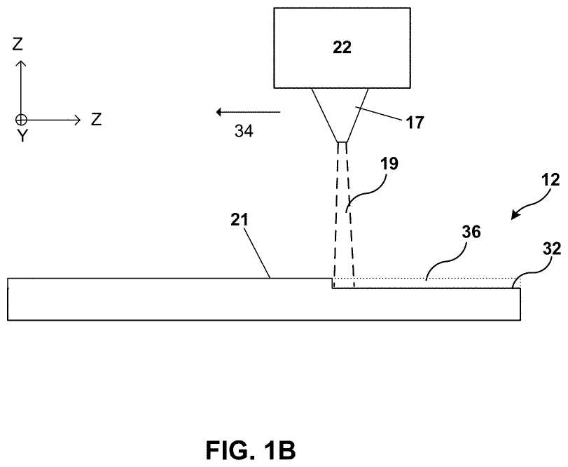

FIG. 2 is a flow diagram illustrating an example technique for abrasively blasting a component according to some aspects of the disclosure. For ease of description, the example of FIG. 2 will be described with respect to system 10 of FIG. 1A. However, any suitable blasting system may be used to carry out the described technique.

As shown computing device 30 may determine the geometry of component 12 using measurement device 20, e.g., using any of the techniques describe herein (40). For example, measurement device 20 may make three-dimensional surface measurement for computing device 30 to determine the three-dimensional surface geometry of component 12. Computing device 30 may make this determination prior to component 12 being grit blasted, e.g., following the manufacture of component 12 using techniques such as casting, forging additive manufacturing, grinding, cutting, CVI, melt-infiltration, spray coating, heat treating, or the like. Thus, surface 21 of component 12 may be considered an unblasted surface. In some examples, prior to grit blasting, the component may be machined to specific dimensions and shape. However, the actual manufacturing of the component may be via reaction bonding, chemical vapor deposition/infiltration, and/or other suitable techniques.

Computing device 30 may then compare the determined geometry of component 12 to a target geometry (42). The target geometry may be the geometry of component 12 desired following grit blasting of component 21, e.g., the desired geometry of component 12 onto which one or coating may then be applied via thermal spray process. In some examples, the target geometry used for the comparison may be in the form of or based on a CAD model.

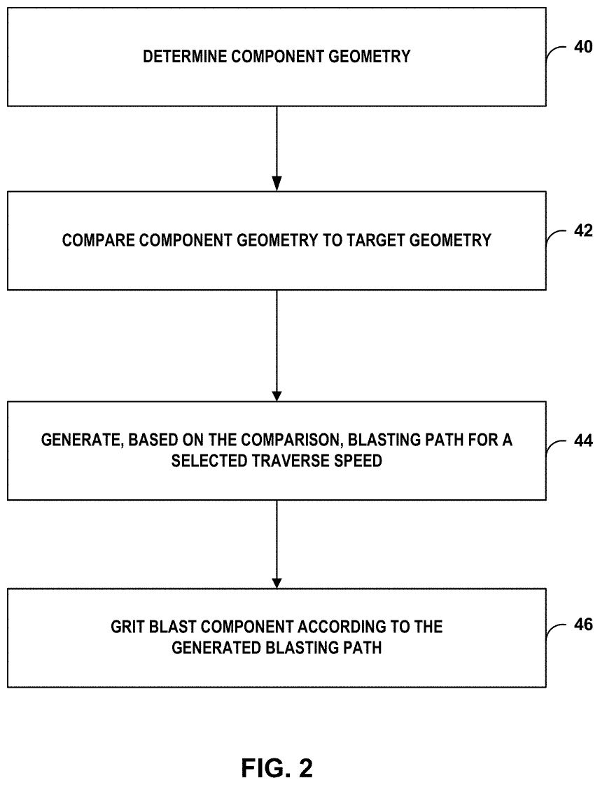

Based on the comparison, computing device 30 may then generate a blasting path for blasting device 22 to follow with nozzle 17 over surface 21 of component 12 while nozzle 17 moves according to a selected traverse speed (44). The selected traverse speed may be a value that is predefined by a user or other input, and it may be unique to the particular type of component being blasted, e.g., based on the material of component 12. The selected traverse speed used to generate the blasting path for device 22 may be the traverse speed that is ultimately employed by blasting device to blast component 12. In some examples, the selected traverse speed may be at least about 350 mm/s, such as about 600 mm/s to about 2000 mm/s, although other values are contemplated. The particular pattern for the blasting path may be fixed, e.g., as a ladder type path like that shown in FIG. 3, but the number of passes over respective sections of the component may be adjusted based on the desired material removal to reach the target geometry.

As described further below, it has been found relatively low traverse speeds typically used in manual or automated grit blasting (e.g., less than 300 mm/s) result in substantial thickness loss for a ceramic or CMC component such as a reaction bonded SiC component. Utilizing the high traverse speed capability (e.g., 350 mm/s or greater, such as 600 mm/s to 2000 mm/s) of automated grit blasting may allow for substantial reduction in the component thickness loss with a small effect on the induced surface roughness. Additionally, higher traverse speeds may shorten the total blasting time required, allowing for more components to be blasted in the same amount of time and reducing the amount of grit used per part which reduces the costs associated with both.

In some examples, the traverse speed used to calculate the blasting path may be selected based on the surface roughness estimated to result from grit blasting of the surface with the selected traverse speed. In some examples, the traverse speed may be selected to provide the blasted surface 32 of component with a surface roughness that is greater than a minimum threshold. The minimum threshold value may be a value that has been determined to provide for desired adhesion to a coating applied to the blasted surface 32 of component 12, e.g., using a thermal spray process such as that described below. In some examples, the selected traverse speed may result in (or be predicted to result in) a surface roughness (Ra) of at least about 1 micron, such as, about 0.5 microns to about 20 microns or at least about 1.3 microns such as about 1.3 microns to about 3 microns, although the values may depend on the constituents of the substrate (e.g., SiC particle size and fraction in reaction bonded SiC material).

In some examples, computing device 30 generates, based on the comparison (42), the blasting path for blasting device 22 to follow with nozzle 17 over surface 21 of component 12 by initially dividing the surface 21 of component 12 into one or a plurality of discrete sections. For each discrete section, computing device 30 may determine the amount of material to be removed from surface 21 of component 12 during the blasting operation by determining the different between the measured geometry for the discrete sections and target geometry for the same sections. Based on the amount of material to be removed, a blasting path over the discrete sections may be generated to provide for the desired amount of material removal from each discrete section of surface 21 when moving nozzle 17 according to the selected traverse speed.

In some examples, an estimated amount of material removed from a portion of component 12 associated with a given traverse speed may be used by computing device 20 to calculate the blasting path. For example, a selected traverse speed may be estimated to remove a particular amount of material or remove material at an estimated rate. Computing device 20 may generate, based on the estimated removal amount or rate of material removal for a selected traverse speed, a blasting path over all or a portion of surface 21 of component 12 that removes the amount of material needed to achieve, e.g., the target geometry given the measured geometry.

The estimated amount of material or material removal rate for a selected traverse speed may be determined in any suitable manner. In some examples, the estimated amount or removal rate for a traverse speed may be a predefined value stored in a memory accessible to computing device 20 (e.g., in a look-up table with a plurality of different traverse speeds and associated estimated removal amounts and/or rates). Those values may be determined based on empirical data and the values may be specific to the type of component material for component 12. In some examples, the removal amount and/or rate for a selected traverse speed may be predetermined by blasting a component, e.g., with substantially the same composition of component 12, at the selected traverse speed and measuring the amount of material removed or rate of removal for the part. This process may be accomplished for a plurality of different traverse rates, e.g., that may be selected for a grit blasting process. In some examples, to predict or otherwise estimate the amount of material removal when calculating the blasting path, computing device 20 uses empirical data for a given grit size at different blast pressures and traverse speeds.

The empirical data may be stored in a memory accessible to computing device 20 and/or may be inputted by a user during the grit blasting process of FIG. 2, e.g., when inputting a selected traverse speed for the process. For a selected traverse speed, the blasting pressure, grit size and/or other blasting parameters of the process used to empirically determine the estimated amount and/or rate of material removal may also be stored or otherwise associated with the traverse speed so that computing device 20 may employ the same or similar parameter values when controlling the grit blasting process with the generated blasting path (46).

In some examples, the empirically determined removal amount and/or rate may be periodically updated, e.g., on a component by component or even between individual passes on the same component. For example, when blasting a series of components in a process, after a first component is grit blasted, the actual amount of material or rate of material removed by the grit blasting process at the selected traverse speed may be determined, e.g., by measuring the geometry before and after the process. This actual amount may be compared to the estimated amount and/or rate originally used to determine the blasting path, and the estimate amount may be updated if there was a deviation between the two values. For example, the estimated amount used to generate the blasting path for the next component may be the value determined to be removed from the prior component or some combination (e.g., average) of the original estimated amount/rate and the amount/rate determined from one or more components in a batch previously grit blasted according to the process of FIG. 2.

Thus, computing device 20 may use empirical data or a model from empirical data for the estimated traverse rate/material removal in the process of FIG. 2 (e.g., at step 44). The estimates may be “known” ahead of the process of FIG. 2, e.g., computing device 20 may have a relationship for a rb SiC or other component type but the estimates may also be generated or refined while blasting a component between passes (blast a pass, then measure to determine the actual removal, refine the estimate to update the generated blasting path, blast another pass, measure again, refine, and so on and so forth) or between component in a batch of components. In such a process, the other blasting parameters (e.g., pressure, grit size, and the like) may be kept constant in part because they are more difficult to change from location to location but you can also see larger changes to surface roughness with changing the other parameters.

Using that amount of material removal, computing device may determine how many passes nozzle 17 needs to make over each discrete section of surface 21, if any, to provide for a blasted geometry of component 12 that is nearest the target geometry (e.g., within some variance). For sections that require more material removal than other sections, the generated blasting path may be defined such that nozzle 17 moves grit plume 19 over those sections with more passes compared to other sections of surface 21 that need less material removed to achieve the target geometry.

After the blasting path is determined, computing device 30 may control blasting device 22 to grit blast surface 21 of component 12 according to the generated blasting path (46). Depending on the generated blasting path, nozzle 17 may be controlled such that grit plume 19 moves over all or only a portion of surface 21 of component at least one time. In some examples, depending on the generated blasting path, nozzle 17 may be controlled such that grit plume 19 moves over all or only a portion of surface 21 of component more than one time, e.g., with some portion of surface 21 being passed over multiple times to achieve the desired amount of material removal.

Computing device 30 may control blasting device 22 such that nozzle 17 moves at a traverse speed relative to component 12 that is substantially the same as the selected traverse speed used for the calculation for generating the blasting path. For example, the actual traverse speed used when following the generated blasting path may be within about 10%, about 5%, about 3% or about 1% percent of the selected traverse speed. In some examples, even if the selected traverse speed and the actual traverse speed are not exactly the same, the actual traverse speed may remove material at substantially the same rate as estimated for the selected traverse speed when calculating the blasting path or within some nominal amount. The actual traverse speed may provide for the desired amount of material removal from component 12 and also provide for the desired surface roughness for the blast surface 32 following the blasting process.

In some examples, the actual traverse speed used during the blasting of component 12 may be substantially constant over the entire generated path, e.g., the actual traverse speed may not vary more than about 10%, about 5%, about 3% or about 1% over the generated blasting path. The traverse speed may vary when the blasting path changes direction over the desired blasting path but may be substantially constant otherwise. In some examples, the process of FIG. 2 may employ relatively high traverse speed for nozzle 17 during the blasting process while following the generated blasting path. In some examples, the traverse speed may be about 100 to about 2000 mm/s, such as, about 250 to about 1000 mm/s. In some examples, the traverse speed may be at least about 350 mm/s, such as about 600 mm/s to about 2000 mm/s, although other values are contemplated.

In some examples, computing device 30 may maintain the actual traverse speed of nozzle 17 over the generated path to be within a threshold range of the selected traverse speed. The threshold range may be predefined, e.g., by a user, and may be defined such that all or substantially all of the speed values within the range may result in substantially the same amount of material removed from surface 21 of component 12 so long at the traverse speed in within the range. As described below, at relatively higher traverse speeds, the amount of material removed by a blasting process may be less dependent on changes to the traverse speed compared to the blasting at a lower traverse speed.

In some examples, the process of FIG. 2 may be repeated once or multiple times. In cases of using the process multiple times, after the first and/or an intermediate instance of the process, the geometry of the blasted surface of component 12 may be measured as described above rather than an unblasted surface like the first instance of the process, and the geometry of the blasted surface may then be compared to the target geometry to generate a blasting path as described above. In some examples, using multiple iterations of the process may allow for more precise removal of material during the process to produce a final blasted component 12 that has an actual geometry that is substantially the same as the target component geometry. Once the blasting process of FIG. 2 is complete, one or more processes may be employed to form one or more coatings on the blasted surface 32 of component 21, e.g., to form an EBC, TBC, and/or abradable coating on blasted surface 32 via thermal spray process.

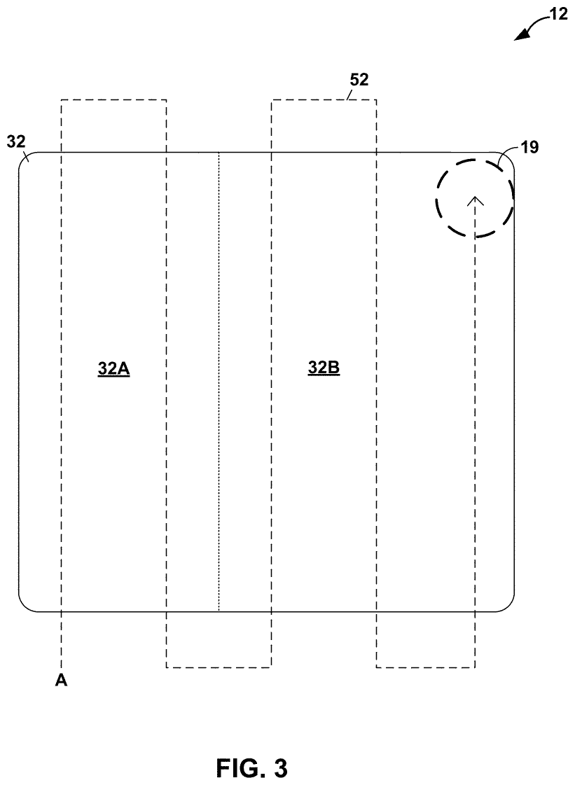

FIG. 3 is a conceptual diagram illustrating an example movement of grit plume 19 over component 12 during a blasting process to form blasted surface 32 with a desired surface roughness and geometry. For example, example blasting path 52 may be generated for a selected traverse speed using the process of FIG. 2. As shown, grit plume 19 starts at point A on or adjacent to the surface of component 12 and moves along blasting path 52 to arrive at the location shown in FIG. 3. Blasting path 52 may be referred to as a “ladder” type path in that the path includes substantially straight passes moving up and down (or side to side) adjacent to each other over the component surface. Grit plume 19 may be moved at a substantially constant traverse speed moving over the surface of component, e.g., as described in some examples of the process of FIG. 2, or more vary, e.g., as described below with regard to the process of FIG. 4. In the example of FIG. 3, the “turns” of blasting path 52 (e.g., to transition from an “upward” pass to a “downward” pass in the ladder pattern may be configured to occur when plume 19 is not on the surface of component since the movement may not be possible while maintaining a substantially constant speed. In other processes, e.g., like that described in FIG. 4, the “turns” of a blasting path may occur with plume 19 on the surface of the component, e.g., since the process may use varying traverse speeds during the blasting process. In FIG. 3, grit plume 19 is shown to define a substantially circular area of abrasion over the surface of component 12 although plume sizes and/or shapes may be employed, e.g., based on the nozzle shape and size and distance of nozzle 17 from component 12.

In the example of FIG. 3, computing device 30 controls blasting device 20 such that plume 19 moves over surface 32 (including sections 32A and 32B) with only a single pass. In other examples, plume 19 may make multiple passes over all or a portion of surface 32 of component 12. For example, plume 19 may pass over first section 32A of component 12 (e.g., along the blasting path 52 shown in FIG. 3 of first section 32A) only a single time but may pass over second section 32B more than once (e.g., by following the portion of blasting path 52 in section 32B multiple times), e.g., if computing device 30 determines that more material should be removed from second section 32B compared to first section 32A based on a comparison to a target geometry as described herein.

Additionally, or alternatively, the traverse speed of nozzle 17 and plume 19 may be different in first section 32A along path 52 compared to section 32B to remove different amounts of material from each discrete section. FIG. 4 is an example flow diagram illustrating such an example technique. Like that of FIG. 2, the example of FIG. 4 may be a technique for abrasively blasting a component to provide a component/part with a desired surface roughness and/geometry. However, as mentioned, in the example of FIG. 4, during a blasting process, the traverse speed of nozzle 17 may be dynamically controlled such that the traverse speed of plume 19 varies at different locations on surface 21 of component 12. For ease of description, the example of FIG. 4 will be described with respect to system 10 of FIG. 1A. However, any suitable blasting system may be used to carry out the described technique.

As shown, like that of the technique of FIG. 2, computing device 30 may determine the geometry of component 12 using measurement device 20, e.g., using any of the techniques describe herein (40). Computing device 30 may then compare the determined geometry of component 12 to a target geometry (42). The target geometry may be the geometry of component 12 desired following grit blasting of component 21, e.g., the desired geometry of component 12 onto which one or coating may then be applied via thermal spray process.

Based on the comparison, computing device may then generate a respective traverse speed for the blasting device relative the component for each section of a plurality of sections of surface 21 of the component 12 (54). As noted above, rather than keeping the traverse speed of grit plume 19 substantially constant while blasting surface 21 of component 12, the technique of FIG. 4 may include moving plume 19 at varying traverse speeds over surface 21 of component 12 to selectively remove an amount of material from surface 21. In some example, the selected amount of material removal may be calculated so that component 12 includes an actual geometry that is substantially the same at the target geometry.

Thus, in some example, computing device 30 may determine the difference between the measured geometry of component 12 and the target geometry, and then determine dynamic adjustments to the traverse speed of plume 19 for plume 19 to be moved by over all or a portion of surface 21 of component 12 to arrive at or near the target geometry. For example, in instances in which lower traverse speeds result in more material removal compared to higher traverse speeds, computing device 30 may generate a set of instructions for defining the blasting of component 12 with the traverse speed being relatively lower in location(s) of surface 21 where the difference between the measured geometry and actual geometry is greater and higher traverse speeds for locations on surface 21 where the difference between the measured geometry and actual geometry is less.

In some example, the different amounts/rates of material removal predicted or otherwise estimated for the different possible traverse speeds may be determined empirically, e.g., with specific material removal amounts/rates associate with each of a plurality of different traverse speeds. The empirical determined estimated amounts and/or removal rates may be specific to particular component composition. The estimated values for each of a plurality of different traverse speeds that may be ultimately used in the blasting process of FIG. 4 may be determined as described above for the process of FIG. 2. In some examples, computing device 30 may access a memory that includes a respective amount of material removal predicted for each of a plurality of traverse speeds or ranges of traverse speeds.

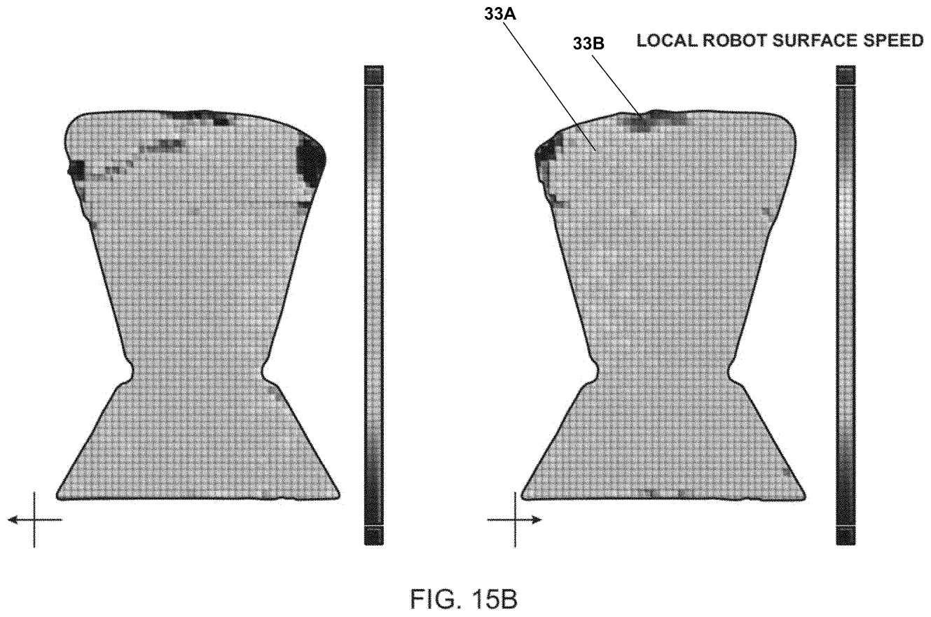

In some examples, computing device 30 may be configured to divide surface 21 of component 12 into a plurality of discrete sections. For each section, computing device 30 may determine the difference between the target geometry for the section and the measure geometry to determine the amount of material targeted from removal from the respective section. Computing device 30 may then determine a respective traverse speed for plume 19 that is predicted to achieve the desired amount of material to be remove, e.g., with a single pass or more than one pass over the respective section. FIGS. 15A and 15B are illustrating of surface deviations for a component front and back determined by a comparison of an actual component geometry to a target geometry (FIG. 15A) and the corresponding local traverse speeds for each respective sections (e.g., individual square sections 33A and 33B) defined over the surface of the component (FIG. 15B). As shown by the shading in FIG. 15B, computing device 30 has determined a respective traverse speed for each square section of the component based on the deviation of the actual surface geometry from the target geometry The traverse speed at section 33A may be different than when plume 19 travels over section 33B based on the different amounts of material to be removed from each respective section, e.g., to achieve the target geometry within each section. The area of the respective section in FIG. 15B may be greater than the area of plume 19 on the surface of the component.

Once computing device 30 determines the traverse speeds for plume 19 to move over the respective sections defining the portion of surface 21 to be blasted, computing device 30 may determine a blast path for plume 19 to follow based on the determined traverse speeds. The determined blast path may include each respective section that includes at least some targeted amount of material to be removed.

Once the desired blasting path and traverse speeds for plume 19 are determined by computing device 30, computing device 30 may control blasting device 22 to grit blast component 12 according to the defined blasting path and varying traverse speeds (56). The other parameters of the grit blasting (e.g., blast pressure, grit size) may be substantially constant during the process and may be those values associated with the empirically determined estimated removal amount/rates associate with each traverse speed. Based on the determined traverse speeds, blasting device 20 may be controlled by computing device in a manner that results in blasting device 20 modifying the traverse speed of plume 19 while moving over surface 21 of component 12. The specific blasting path for the grit blasting process may be determined using any suitable technique. In some examples, plume 19 may be controlled to follow a ladder-type blasting path as described above with regard to FIG. 3. In such a process, the traverse speed may be varied moving from section to section along the linear path based on the traverse speed determined for each respective section. For sections in which not material removal is needed, computing device 20 may temporarily stop the blasting of grit (e.g., by reducing the blast pressure a nominal amount) or may move over the section at a relatively high speed that does not remove more than a nominal amount of material. In some examples, a non-ladder type path may be followed with the blasting path moving from section to section in a non-linear path.

In some examples, computing device 30 may employ a model or other technique to identify traverse rates for each respective section on surface 21 of component 12 that will achieve the desired blasted component dimension in one or multiple grit blasting passes. In some examples, when employing such a process, computing device 30 generates a multidimensional array of traverse rates and blasting positions. Each blasting position may correspond to a discrete section on a surface of the component, with the surface of the component being divided into discrete sections. On a flat component surface this may be traverse speed, X-position, and Y-position. However, on a more complex three-dimensional surface this could include traverse speed, X-position, Y-position, Z-position, blasting nozzle vector, turntable position, and/or the like). In some examples, computing device 30 may check the generated array for spatial resolution (e.g., given the spot size of the grit plume 19) and movement/acceleration capabilities of blasting device 22.

In some examples, the traverse speeds used for plume 19 during the blasting process may include one or more of those speeds or ranges of speeds described above with regard to the process of FIG. 2. In some examples, the traverse speeds employed for the grit blasting process may range from about 100 to about 2000 mm/s, such as, about 250 to about 1000 mm/s. The traverse speeds employed for the grit blasting process may be provide for a surface roughness of blasted surface 32 of at least about 0.5 microns, such as, about 1 to about 20 microns.

Once the grit blasting of component 12 is complete (56), computing device 30 may determine if the resulting geometry of component 12 after blasting is the same as geometry as desired for component 12 (or within a particular threshold variance) (58). This geometry may be the same as the target geometry used to determine the traverse speeds adjustments over the surface of component 12 during the grit blasting. The determination may be made, e.g., by measuring the geometry of the blasted component 12 using measuring device 20, and then comparing the measured geometry to the target or other desired geometry, as described above.

If the actual geometry of the blasted component 12 is acceptable (yes path of decision block 58), then one or more coatings may be optionally applied to blasted surface 32 of component 12 (60). As described herein, the surface roughness of blasted surface 32 resulting from the blasting process may provide for desired adhesion to subsequently applied coatings. However, if the actual geometry of the blasted component is not acceptable (no path of decision block 58), then another iteration of grit blasting may be carried out, e.g., according to the technique of FIG. 4 using variable traverse speeds and/or according to the technique of FIG. 2 using a substantially constant traverse speed.

Thus, the process of FIG. 4 may be performed in a single iteration or multiple iterations. In the case multiple iterations, the traverse speeds employed at the earlier stages may be selected to remove more material from surface 21 of component 12 with the later stages using traverse speeds that remove less material from an intermediate stage blasted surface of component 12, e.g., to allow for more precise removal of material from component 12. In other examples, each iteration may employ the same or similar range of traverse speeds.

In addition to varying the traverse speed for the process of FIG. 4, in some examples, the blasting process may further be controlled by varying the plume spot size to control the amount of surface area that is grit blasted moving over a section of the surface of the component. This may be accomplished statically by selecting nozzles of smaller or larger diameter (or other nozzle opening size) or dynamically by controlling the blast pressure and/or distance, or by employing a variable diameter/outlet nozzle. A smaller spot size may allow for higher precision of material removal and more careful modification of component features (for example for blasting paths around cooling holes, optimizing for radii or leading edges) while a larger spot size can offer more efficiency, e.g., in terms of material rate.

Aspects of the example technique of FIG. 4 may be better described with reference to the conceptual diagram of FIG. 3. For example, using the technique of FIG. 4, computing device 30 may measure the actual geometry of component 12 (40) and then, for each of first section 32A and second section 32B prior to blasting, determine a difference between the actual geometry of each section to the target geometry for each section. In the case where computing device 30 determines, based on the comparison, that more material should be removed from first section 32A than second section 32B, computing device 30 may employ a first traverse speed along the portion of path 52 in first section 32A and a second traverse speed different from the first traverse speed when moving along the portion of path 52 in second section 32B. The respective traverse speeds may be selected by computing device 30 such that the amount of material predicted to be removed from each respective section (e.g., in a single or multiple passes) results in sections 32A and 32B being at or with an threshold variance of the target geometry for each section. Likewise, the respective traverse speeds may be selected such that sections 32A and 32B exhibit a targeted surface roughness or are within a range of targeted surface roughness (e.g., above a minimum threshold surface roughness).

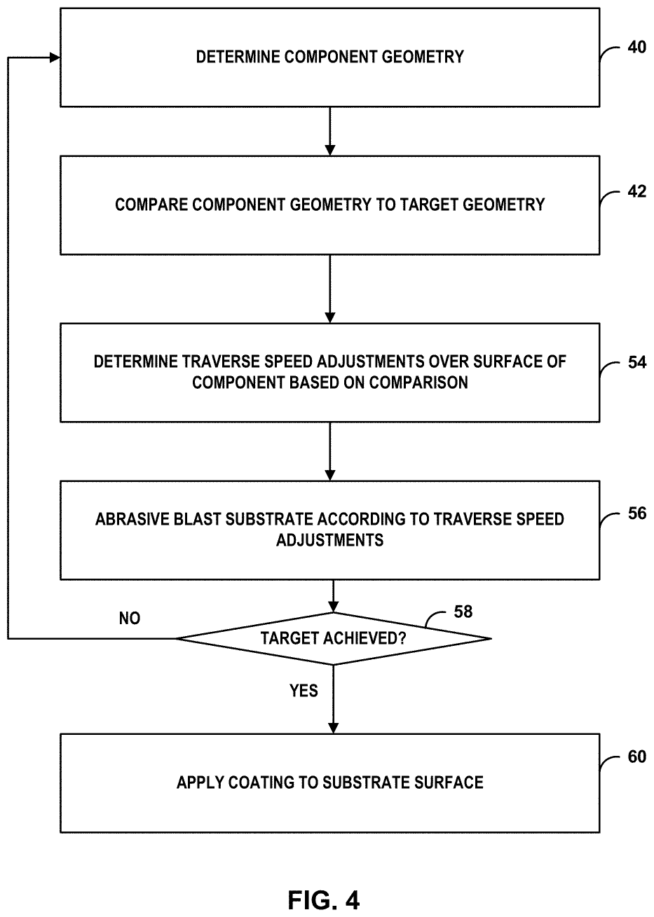

FIG. 5 is a flow diagram illustrating an example technique for manufacturing a component with one or more coatings formed on the surface of a substrate. For example, an uncoated and unblasted component may be abrasively blasted using one or more of the example techniques described herein to provide for a blasted component having a desired surface roughness and desired geometry (64).

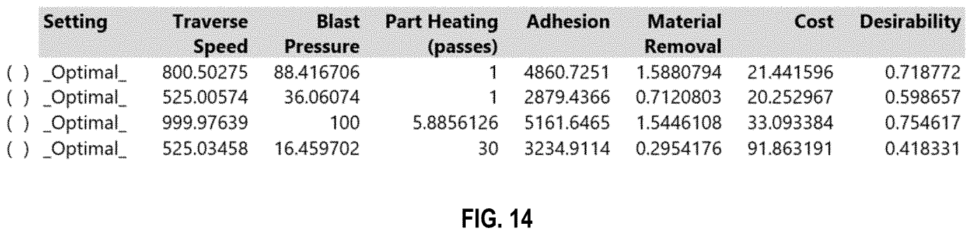

Following the grit blasting of component 12, component 12 may optionally be heated in combination with the deposition of a coating on surface 32 of component 12 (66). For example, component 12 may be pre-heated such that the surface temperature of component 12 is elevated during the deposition of a coating material on surface 32 of component 12. In some examples, the optional heating of component 12 may be carried by a thermal spray device used to deposit a coating by passing the thermal spray torch over the component surface without powder or other coating material flowing. Additional component heating methods include localized resistive heating element, torches, spray environment heating (HVAC or spraying in a furnace), or other methods. In some examples, increasing part temperature may increases coating adhesion (e.g., as seen in FIG. 13 described below) but may also increases process cost and processing time.

Following the grit blasting of component 12 (as well as with the optional heat treatment), a coating may be formed on surface 32 of component 12 using, e.g., a thermal spray process (68). The coating may be any suitable coating including, e.g., an EBC, TBC, and/or abradable coating. As described herein, the surface roughness of component 12 following the grit blasting process may provide for better adhesion of coating formed on the roughened surface. Example thermal spray processes may include suspension plasma spray, low pressure plasma spraying, plasma spray physical vapor deposition, and air plasma spraying. Example depositing systems for forming a coating on the surface of component 12 after component 12 has been grit blasted according to one or more the techniques described herein may also include one or more of the examples described in U.S. patent application Ser. No. 16/884,841, by Li et al., the entire content of which is described herein.

Example EBCs that may be deposited on blasted surface 32 may include one or more EBC layers, which may be configured to help protect component 12 against deleterious environmental species, such as CMAS and/or water vapor. The one or more EBC layers may include at least one of a rare-earth oxide, a rare-earth silicate, an alurninosilicate, or an alkaline earth aluminosilicate. For example, an EBC may include mullite, barium strontium aluminosilicate (BSAS), barium aluminosilicate (BAS), strontium aluminosilicate (SAS), at least one rare-earth oxide, at least one rare-earth monosilicate (RE₂SiO₅, where RE is a rare-earth element), at least one rare-earth disilicate (RE₂Si₂O₇, where RE is a rare-earth element), or combinations thereof. The rare-earth element in the at least one rare-earth oxide, the at least one rare-earth monosilicate, or the at least one rare-earth disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc).

The TBCs deposited on surface 32 of component 12 may include a composition to provide thermal cycling resistance, a low thermal conductivity, erosion resistance, combinations thereof, or the like. In some examples, the coating may include zirconia or hafnia stabilized with one or more metal oxides, such as one or more rare earth oxides, alumina, silica, titania, alkali metal oxides, alkali earth metal oxides, or the like. For example, the coating may include yttria-stabilized zirconia (ZrO₂) or yttria-stabilized hafnia, or zirconia or hafnia mixed with an oxide of one or more of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc).

As one example, the coating may include a rare earth oxide-stabilized zirconia or hafnia layer including a base oxide of zirconia or hafnia and at least one rare-earth oxide, such as, for example, at least one oxide of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc). In some such examples, the coating may include predominately (e.g., the main component or a majority) the base oxide including zirconia or hafnia mixed with a minority amount of the at least one rare-earth oxide.

In some examples, the deposited coating may include an optional bond coat formed on blasted surface 32 of component 12. As used herein, “formed on” and “on” mean a layer or coating that is formed on top of another layer or coating, and encompasses both a first layer or coating formed immediately adjacent a second layer or coating and a first layer or coating formed on top of a second layer or coating with one or more intermediate layers or coatings present between the first and second layers or coatings. In contrast, “formed directly, on” and “directly on” denote a layer or coating that is formed immediately adjacent another layer or coating, e.g., there are no intermediate layers or coatings.

In some examples, the bond coat of an EBC system may be directly on substrate. The bond coat may be between an EBC layer and substrate 12 and may increase the adhesion of the EBC layer to substrate 12. In some examples, the bond coat may include silicon and take the form of a silicon bond layer. In some examples, the bond coat may include silicon, a metal silicide, RE monosilicate, RE disilicate, hafnium silicate, mullite, SiC, a metal oxide or a mixture thereof.

Example techniques for forming a coating on the surface of component 12 after component 12 has been blasted according to one or more the techniques described herein may also include one or more of the example techniques described in U.S. Published Patent Application Nos. 2019/0039084; 2019/0039082; 2019/0039083; and 2019/0041192. The entire contents of these applications are incorporated by reference herein. Further, one or more of the examples techniques described by these applications related to adaptively controlling the thickness of a deposited coating based in part on a target geometry of the coated component may be employed but with the adaptive adjustments made to one or more parameters of the grit blasting process described herein, e.g., to tailor the removal of a material from component 12 to provide for a targeted geometry for component 12 after grit blasting.

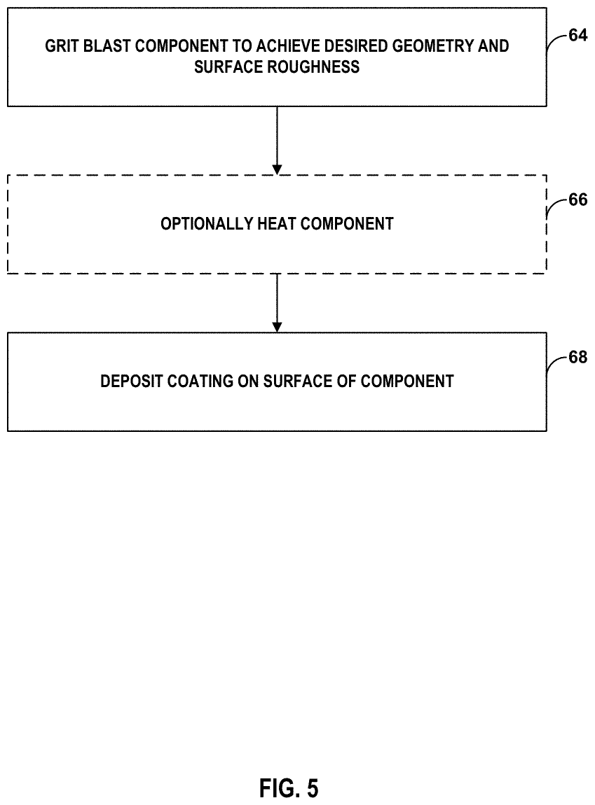

The techniques of FIGS. 2 and 4 may include techniques for controlling a grit blasting process to provide for a desired geometry of a component and/or a desired surface roughness (e.g., using relatively high traverse speed(s)). In some example, such techniques may be in a manner that statistically optimizes or improves a grit blasting process for surface preparation of a component to provide for maximum or improved adhesion for a coating applied to the component surface after grit blasting as well as target material removal of the component with grit blasting at minimum or reduced cost. In some examples, the process may include measuring the geometry of a component, identifying target surface dimensions of the component, and then calculating the optimal or beneficial grit blasting and heating parameters. The heating parameters may relate to the pre-heating of component 12 in combination the formation of a coating on the surface of component as described in FIG. 6 to improve the adhesion of the coating to the surface of substrate 12.

As one example, a technique may include the control of grit blasting traverse rate, blasting parameters, and/or component heating temperature, to control cost, surface loss, and adhesion for a coating formed on the component (e.g., using a thermal spray process). Such an example may produce two desired outcomes: improved part tolerances and coating adhesion.

FIG. 6 is a conceptual diagram illustrating an example control scheme in accordance with some examples of the disclosure. For ease of description, the example of FIG. 6 will be described with respect to system 10 of FIG. 1A. However, any suitable blasting system may be used to carry out the described control scheme. The control schemed may be employed in combination with, e.g., the techniques of FIGS. 2, 4, and 5.

Computing device 30 may receive one or more inputs (e.g., from a human operator) and, based on the predicted inputs, generated an estimated and/or predicted output of a blasting and coating process according to the inputs. For example, as shown in FIG. 6, computing device 30 may analyze a proposed blasting and coating process using the inputs of traverse speed(s) during the blasting process, one or more other variables for the grit blasting process, and/or the temperature used for component pre-heating during the coating process following the grit blasting.

Based on the input, computing device 30 may predict the amount of material removed from the component with the grit blasting process carried out with the specified inputs, the predicted adhesion of the coating to the component surface for a coating process carried out with the specified heating temperature, and the predicted cost of the overall process. Computing device 30 may analyze different sets of values for each of the input relative to each other based on the predicted outputs and, based on the calculated outputs, identify a optimum or otherwise desirable set of inputs to actually employ, e.g., in a process according to FIGS. 2, 4, and/or 5.

For the traverse speed input, as described herein, examples of the disclosure may include robotic blasting system that may employ relatively high traverse speeds compared to some manually controlled systems. In some examples, high traverse speed capability (e.g., greater than 350 mm/s, such as 600 mm/s to 2000 mm/s) of automated grit blasting may allow for substantial reduction in the Rb SiC substrate thickness loss with a small effect of decreasing the induced roughness. Additionally, higher traverse speeds may shorten the total blasting time required, allowing for more parts to be blasted in the same amount of time and reducing the amount of grit used per part which reduces the costs associated with both.

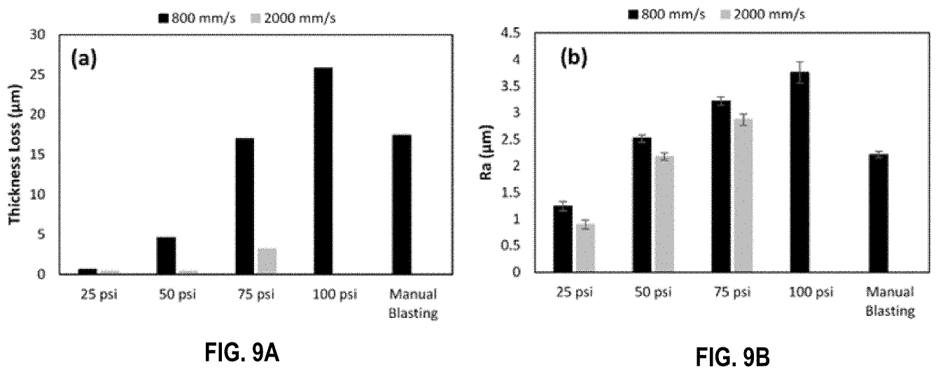

The input for the example of FIG. 6 may include one or more additional parameters for the grit blasting process. The additional grit blasting parameters may be varied to control material removal and surface roughness with the blasting process. Blast parameters such as blast pressure can be varied to achieve a desired roughness and adhesion. Higher pressures may increase roughness but may also increase material removal as seen in FIGS. 9A and 9B. Other blasting parameters such as blast angle, standoff, blast media may be used for this in addition or separately.

The input for the example of FIG. 6 may include the pre-heating temperature of the component, e.g., with the thermal spraying of the component after the grit blasting. Component temperature during thermal spraying may be controlled in a number of ways, including passing the thermal spray torch over the component surface without powder flowing. Additional passes increase component temperature. Additional component heating methods include localized resistive heating element, torches, spray environment heating (HVAC or spraying in a furnace), or other methods. Increasing part temperature may increases coating adhesion as seen in FIG. 13 but may also increases process cost and processing time.

Additional considerations may include the dimensions of a component or components. For example, tolerance stacks on components may vary widely and can mean the difference between a new technology (such as CMCs) adding value and not being financially feasible. There are not many ways to control part tolerances outside their manufacturing process, ultimately this may lead to applying coatings extra thick in order to then be machined to proper size. Additional machining of parts is costly and time consuming. Part dimensions are generally already being measured after manufacturing before coating. Thus, the desired amount of material removal can be determined, e.g., using the techniques described herein, without a significant increase process steps.

The measured/predicted outputs of the example control scheme of FIG. 6 may include: material removal (FIG. 8 illustrates that traverse rate may allow for precise control of material removal rates); coating adhesion estimate, (e.g., the coating adhesion strength may be predicted from grit blasting parameters and part temperature as illustrated in FIGS. 7, 8, and 13); and/or cost/amount of part heating. As described above, the predicted outputs may be used to evaluate multiple different set of input variables to identify the particular set of inputs that may provide for a desired level of coating adhesion between a thermally sprayed coating and a grit blasted component at a desired cost per component.

### EXAMPLES

Various tests were carried out to evaluate one or more aspects of the disclosure related to abrasive blasting of ceramic or CMC component substrates. At least some of those tests are summarized below with relevant discussion. Further discussion and details of the testing are also described in the following publication: Scherbarth, A.D., et al. Effects of Automated Grit Blasting on Roughness and Thickness Loss of Reaction-Bonded Silicon Carbide. J Therm Spray Tech (2021). https://doi.org/10.1007/s11666-021-01169-z. The entire content of this publication is incorporated herein by reference and constitutes part of this disclosure. The below discussion and examples and those in the above referenced publication are included to illustrate aspects of some examples of the disclosure but do not limit the scope of the present disclosure.

Because of their low density, high temperature capability and resistance to oxidation, there has been tremendous interest in the use of ceramics and ceramic matrix composites (CMCs) substrates, like SiC fiber reinforced SiC, for components in harsh environments such as the hot section of jet engines or other high temperature gas turbine engines. Ceramic and CMC substrates may need an environmental barrier coating for thermal insulation and protection from water vapor attack in the engine environment.

A number of methods may be used to apply these coatings, but atmospheric plasma spraying (APS) is commonly used because it is commercially available and cost effective relative to other techniques. Adequate adhesion of the coating to the substrate is desirable for proper coating performance. Substrate surface preparation prior to coating is critical to coating buildup during thermal spraying and coating adhesion. A roughened surface may have a profile which facilitates a mechanical interlocking of the coating with the substrate, and grit blasting is an abrasive blasting technique used for roughening a surface before coating the substrate, e.g., because of its relatively low cost and easy implementation.

There is still a lack of knowledge related to the effects of grit blasting (and other abrasive blasting techniques) on ceramics and ceramic matrix composites (CMCs). The nature of material removal of ceramics differs significantly from metals, as ceramics typically exhibit brittle behavior and lower fracture toughness, and this may affect the roughening behavior. In addition, reaction bonded silicon carbide (rb SiC) composites are expected to be comparable in many respects to the surface of CMC components, and may potentially behave differently than monolithic SiC material.

Grit blasting is one example cost effective method for cleaning and roughening a substrate surface prior to thermal spray coating to ensure sufficient coating to substrate adhesion. A concern associated with roughening a surface via grit blasting is the effect it may have on the surface and mechanical properties of the substrate. Grit blasting can remove a relatively large amount of material, and this must be planned for when preparing a surface for coating. Reducing material removal and the effects on surface/mechanical properties while creating a surface which promotes mechanical interlocking during thermal spray coating is ideal. The effect of grit blasting and specific grit blasting parameters on degree of material or thickness loss is important to consider, especially for parts that have tight dimensional tolerances, have a protective top surface layer, or are more sensitive to grit blasting. Additionally, grit wear is another concern with grit blasting as worn grit must be replaced with new grit. Reducing the amount of grit that is used or worn per part would reduce cost as grit would be replaced less often.

With respect to surface roughening of a ceramic or CMC substrate via grit blasting, the induced roughness, amount of substrate material removed and grit wear depends on multiple different factors. Grit material and size, substrate material and properties, and grit blasting parameters, especially blast nozzle traverse speed (blasting time) and blast pressure, may all affect the degree to which substrate material will be removed. Grit blasting may be done manually, in which there is much room for human error and little ability to consistently and accurately control the blast nozzle position to the same degree as automated blasting, especially with different operators.

Mounting the blast nozzle to a programmable robot arm, as may be done in automated grit blasting, may allow for strict, consistent control of nozzle position and associated blast parameters, e.g., blast angle and traverse speed. The capabilities and differences associated with the use of an automated robot during blasting are much less documented, but of strong interest for improving the consistency of the process. The blast parameters of interest, such as pressure, angle, grit mass flow rate, standoff distance, nozzle traverse speed and grit size may affect the resulting roughness of the blasted surface. In addition to the increased overall degree of control provided by automated grit blasting, the use of consistent, controlled nozzle traverse speeds that are relatively high, e.g., above 350 millimeters/second (mm/s), may be used during (robotic) blasting.

As noted above, some examples of the disclosure relate to grit blasting of a reaction bonded silicon carbide composite substrate (rb SiC) but may also be applicable to other types of silicon carbide and to silicon carbide/silicon carbide ceramic matrix composites or other ceramics or other ceramic composites. The representative testing data shown is meant as an example, but should not be interpreted as intending to limit the scope of the disclosure to only these samples or process parameters as would be evident to one skilled in the art. As a system representative of silicon carbide materials and standard grit blasting procedures, reaction bonded silicon carbide samples with about 30% free silicon were tested using 220 SiC grit with average grit size of 63 μm, but this could be relevant for a variety of grit and substrate materials. Traverse speeds typically used in manual or automated grit blasting (less about 300 mm/s) result in substantial thickness loss for a rb SiC substrate. Utilizing the high traverse speed capability (above 350 mm/s, such as about 600 mm/s to 2000 mm/s) of automated grit blasting may allow for substantial reduction in the rb SiC substrate thickness loss with a small effect on the induced roughness. Additionally, higher traverse speeds may shorten the total blasting time required, allowing for more parts to be blasted in the same amount of time and reducing the amount of grit used per part which reduces the costs associated with both.

FIG. 7 shows that, for the silicon carbide sample described above, the surface roughness (Ra) resulting from grit blasting decreased only slightly with increasing traverse speed of the grit blasting process. The error bars in FIG. 7 correspond to ±one standard deviation. When increased from 300 to 1500 mm/s, surface roughness decreased by 0.7 μm at 75 psi and by 0.3 μm at 50 psi.

FIG. 8 illustrates the measured thickness loss for these tests. The change in thickness loss of the substrate was much greater compared to the change in surfaced roughness as traverse speed was increased. As shown in FIG. 8, the measured thickness loss at 300 mm/s and 75 psi was observed to be about 40 times larger than the thickness loss at 1500 mm/s. At 50 psi, the thickness loss was reduced from 21 μm to 1 μm upon increasing traverse speed from 300 to 800 mm/s. At 300 and 600 mm/s with a blast pressure of 75 psi, thickness loss was seen to be about twice that of samples when a pressure of 50 psi was used, and the higher pressure typically resulted in quite higher thickness loss. At a 1500 mm/s traverse speed, thickness loss was measured to be ≤1 μm (beyond the limits of the 10 micrometer) at 50 and 75 psi. These results indicated that slow traverse speeds cause a large amount of material removal, and that material loss can be substantially reduced and precisely controlled while maintaining high surface roughness by utilizing higher traverse speeds during blasting.

Despite the small effect of traverse speed on surface roughness, it was observed once again to play a dramatic role in the thickness loss after grit blasting, even when comparing two relatively high traverse speeds, 800 and 2000 mm/s. FIGS. 9A and 9B are plots of measured thickness loss values (FIG. 9A) and average surface roughness values (FIG. 9B) for samples after being grit blasted at different blast pressure and traverse speeds. As shown, the decrease in thickness loss upon increasing traverse speed to 2000 mm/s from 800 mm/s was substantial, especially for blast pressures of 50 and 75 psi. Thickness loss was shown to be about 5 times higher at 800 mm/s for both 50 and 75 psi. In FIGS. 9A and 9B, thickness loss and Ra values are included for an rb SiC sample which was manually grit blasted at 50 psi, an approximately 70 degree blast angle, 100 mm/s traverse speed and six inch standoff distance in two orthogonal passes with the same grit media for comparison with those blasted in this study using an automated setup. Based on the plot of FIG. 9A, it is clear that the high traverse speed capability of automated blasting greatly reduced the measured thickness loss compared to that of manual grit blasting and slower traverse speeds. In addition, induced surface roughness values are similar or higher than that of the manually blasted samples despite the greatly reduced thickness loss. The advantage of utilizing high nozzle traverse speeds was clearly seen as an average surface roughness of 2.87 μm was obtained with a measured thickness loss less than 5μm when blasted at 75 psi, 85° and 2000 mm/s, while standard manual grit blasting resulted in an average surface roughness of 2.21 μm and a thickness loss of 17 as seen in FIGS. 9A and 9B. Values for samples blasted at 100 psi, 800 mm/s and with the standard manual blasting procedure are included in FIGS. 9A and 9B for comparison. However, no samples were blasted at 100 psi and 2000 mm/s or manually at 2000 mm/s, and these values are not plotted.

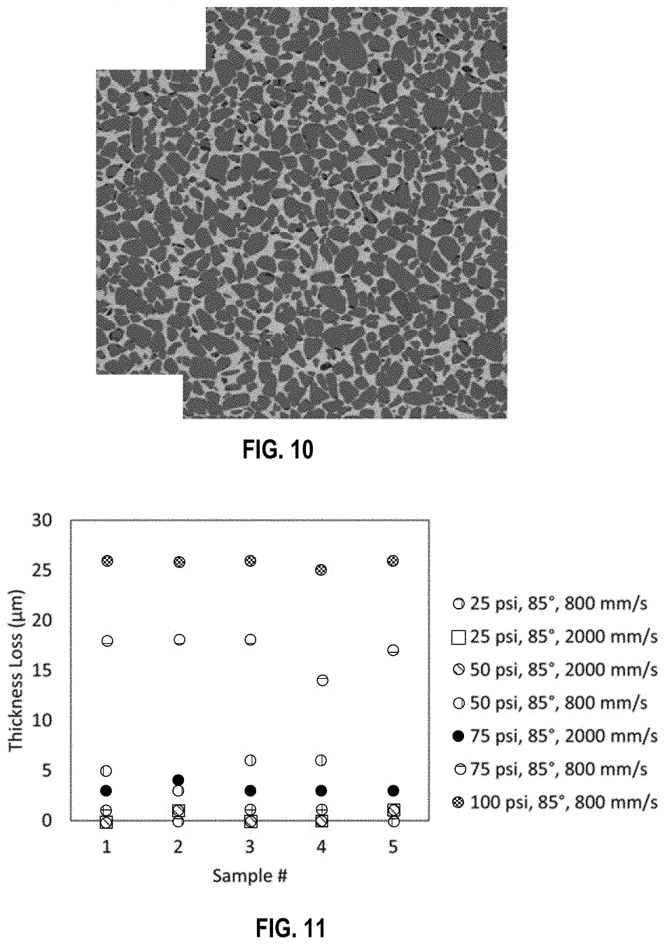

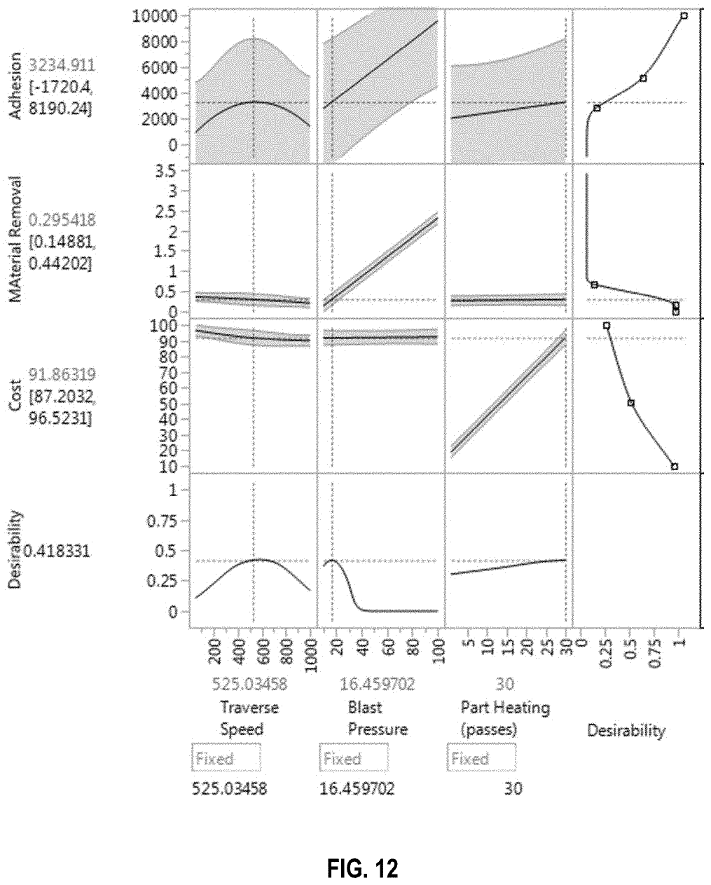

FIG. 10 is a laser scanning microscope image of the surface of rb SiC substrate used for some of the testing, which has been polished to show the microstructure of the rb SiC material. FIG. 11 is a plot of thickness loss for samples at various pressure, blast angles, and traverse speeds. The results showed that repeatability and control of thickness loss by automated grit blasting.

As describe above, some examples of the disclosure relate to a process that combines control of robotic grit blasting traverse rate, other blasting parameters, and/or component temperature for the thermal spraying of one or layers of material to control cost, surface loss, and/or adhesion for a thermal sprayed coating. In some examples, such a process may provide desired outcomes of improved component/part tolerances and/or coating adhesion.

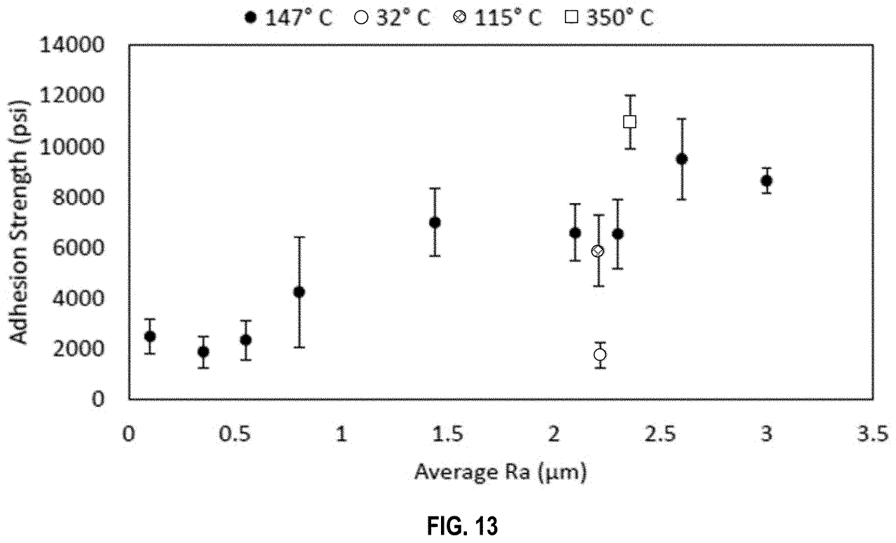

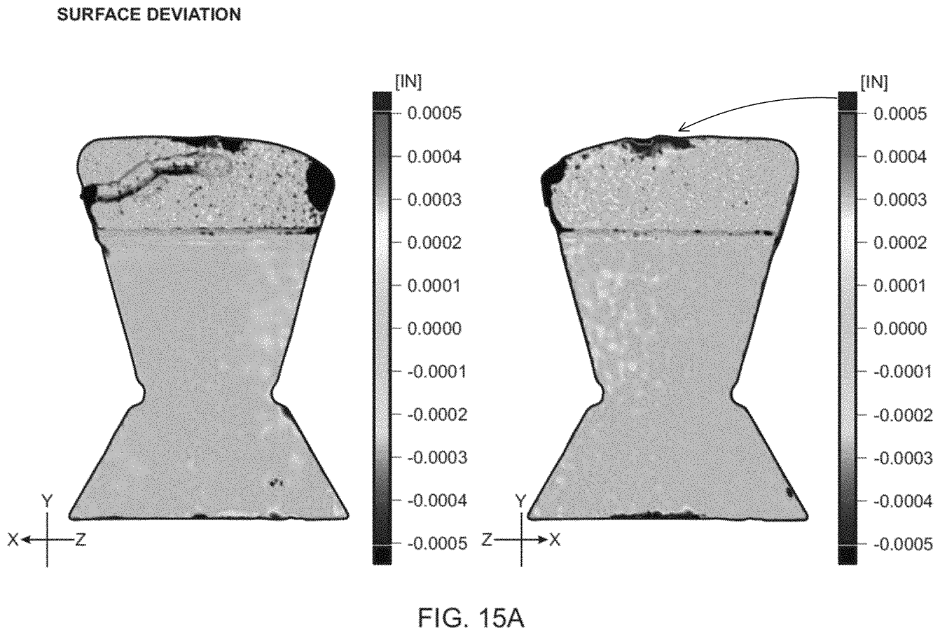

One benefit of using such a control scheme is that there may be offsetting or competing inputs and outputs. For example, increasing blast parameters to achieve a higher roughness (Ra) and adhesion may result in more material removal; precisely controlling the material removed may limit the achievable coating roughness and may potentially limit coating adhesion. Increasing part temperature can add time/equipment/complexity or other costs to the process but aids in adhesion. So, while for a desired set of outputs there may be statistically optimal set of inputs, at the same time there may be a variability in part manufacturing which results in changes to the desired target material removal, and therefore an optimal set of inputs must be determined for each part that balances target material removal, maximizes coating adhesion, and minimizes costs. Example responses and optimal solutions are shown in FIG. 12 and the table of FIG. 14.

There may be some need to batch samples for the preheating/coating portion of the process (could also be done for the grit blasting portion but robotically this is more easily varied part to part), so a set of parts would have conditions calculated independently and then the ones with the same or similar heating requirements would be coated simultaneously. To aid in this the potential levels for heating could be constrained to limited values instead of a continuous range.

FIG. 12 shows examples output responses to input parameters and desirability functions used to find an optimal solution for a particular material removal target. The plots illustrate a process to optimize each traverse speed, blast pressure, component heating (expressed in number of passes of a torch over a part surface)) based on estimated cost, material removal and adhesion, e.g., to generate a set of traverse speed, blast pressure, and component heating that provides for minimal cost and material removal with beneficial adhesion of a coating to the component surface.

FIG. 13 shows an example plot of coating adhesion strength as a function of surface roughness (Ra) and substrate preheat temperature for components when forming a coating on the surface of a component via a thermal spray process. As shown, increasing component (substrate) temperature may increase coating adhesion but may also increase process cost and processing time.

FIG. 14 is a table showing example calculated optimal solutions and predicted outcomes for four different target material removals. The input for the calculations were traverse rate, blast pressure, and part (component) heating passes, which generated the outputs of material removal, cost, and coating adhesion. As shown in the table of FIG. 14, there were four different scenarios with optimal outputs for each with different inputs.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following clauses and claims.

Clause 1A. A method comprising: comparing, by a computing device, a geometry for a component to a target geometry for a blasted component, wherein the component comprises a metallic, a ceramic or ceramic matrix composite component; generating, by the computing device and based on the comparison, an abrasive blasting path over a surface of the component for a selected traverse speed; and controlling, by the computing device, an abrasive blasting device to abrasively blast the component with the generated abrasive blasting path to remove material from the surface of the component.

Clause 2A. The method of clause 1, wherein a traverse speed during the abrasive blasting of the component with the generated blasting path is substantially the same as the selected traverse speed, and wherein the traverse speed is substantially constant during the abrasive blasting of the component of the abrasive blasting path.

Clause 3A. The method of clause 1A, wherein a traverse speed during the abrasive blasting of the component with the generated blasting path is within a threshold range of the selected traverse speed.

Clause 4A. The method of clause 3A, wherein the abrasive blasting is configured to remove approximately the same amount of material from the surface of the component for all traverse speeds with the threshold range.

Clause 5A. The method of clause 1A, wherein the abrasive blasting path over the surface of the component is generated to achieve the target geometry for the component following abrasive blasting.

Clause 6A. The method of clause 1A, wherein the generated abrasive blasting path includes an overlapping portion such that, during the abrasive blasting, a portion of the component is blasted by an abrasive plume more than one time.

Clause 7A. The method of clause 1A, further comprising receiving an input selecting the traverse speed.

Clause 8A. The method of clause 1A, wherein the selected traverse speed is about 350 millimeters/second or greater.

Clause 9A. The method of clause 8A, wherein the selected traverse speed is from about 600 millimeters/second to about 2000 millimeters/second.

Clause 10A. The method of clause 1A, wherein the blasted component has a surface roughness of at least about 1.5 microns following the abrasive blasting.

Clause 11A. The method of clause 1A, further comprising forming a coating on the blasted component following the abrasive blasting, the coating comprising at least one of a bond layer, an environmental barrier coating or a thermal barrier coating.

Clause 12A. The method of clause 11A, further comprising preheating the roughened component prior to the formation of the coating on the roughened component.

Clause 13A. The method of clause 12A, further comprising identifying the selected traverse speed for the blasting process and a heating temperature for the preheating step from a plurality of sets of values based on a predicted level of material removal, adhesion and cost predicted for each set of values of the plurality of sets of values.

Clause 14A. An abrasive blasting system comprising: abrasive blasting device configured to deliver an abrasive material to a surface of a component to blast a surface of the component with the abrasive material, wherein the component comprises a metallic, a ceramic or ceramic matrix composite component; and a computing device, wherein the computing device is configured to: compare a geometry for the component to a target geometry for a blasted component, wherein the component comprises a ceramic or ceramic matrix composite component; generate, based on the comparison, an abrasive blasting path over a surface of the component for a selected traverse speed; and control the abrasive blasting device to abrasively blast the component with the generated abrasive blasting path to remove material from the surface of the component.

Clause 15A. The system of clause 14A, wherein the computing device controls the blasting device such that a traverse speed during the abrasive blasting of the component with the generated blasting path is substantially the same as the selected traverse speed, and the traverse speed is substantially constant during the abrasive blasting of the component of the abrasive blasting path.

Clause 16A. The system of clause 14A, wherein the computing device controls the blasting device such that a traverse speed during the abrasive blasting of the component with the generated blasting path is within a threshold range of the selected traverse speed.

Clause 17A. The system of clause 16A, wherein the abrasive blasting is configured to remove approximately the same amount of material from the surface of the component for all traverse speeds with the threshold range.

Clause 18A. The system of clause 14A, wherein the computing device generates the abrasive blasting path over the surface of the component to achieve the target geometry for the component following abrasive blasting.

Clause 19A. The system of clause 14A, wherein the generated abrasive blasting path includes an overlapping portion such that, during the abrasive blasting, a portion of the component is blasted by an abrasive plume more than one time.

Clause 20A. The system of clause 14A, wherein the computing device is configured to receive an input selecting the traverse speed.

Clause 21A. The system of clause 14A, wherein the selected traverse speed is about 350 millimeters/second or greater.

Clause 22A. The system of clause 21A, wherein the selected traverse speed is from about 600 millimeters/second to about 2000 millimeters/second.

Clause 23A. The system of clause 14A, further comprising a thermal spray device configured to form a coating on the blasted component following the abrasive blasting, the coating comprising at least one of a bond layer, an environmental barrier coating or a thermal barrier coating.

Clause 24A. The system of clause 23A, wherein the thermal spray device is configured to preheat the roughened component prior to the formation of the coating on the roughened component.

Clause 25A. The system of clause 24A, wherein the computing device is configured to identify the selected traverse speed for the blasting process and a heating temperature for the preheating step from a plurality of sets of values based on a predicted level of material removal, adhesion and cost predicted for each set of values of the plurality of sets of values.

Clause 1B. A method comprising: comparing, by a computing device, a geometry for a component to a target geometry for a blasted component, wherein the component comprises a metallic, a ceramic or ceramic matrix composite component; generating, by the computing device and based on the comparison, a respective traverse speed for a blasting device relative the component for each section of a plurality of sections of a surface of the component; and controlling, by the computing device, an abrasive blasting device to abrasively blast the component according to the respective traverse speeds relative the component generated for the plurality of sections of the surface of the component to remove material from the surface of the component.

Clause 2B. The method of clause 1B, further comprising determining a target material removal for each section of the plurality of sections based on the comparison, wherein generating the respective traverse speed for the blasting device relative the component for each section of the plurality of sections of the surface of the component includes generating, based on the target material removal at each section for the plurality of sections, the respective traverse speed for the blasting device relative the component for each section of the plurality of sections of the surface of the component.

Clause 3B. The method of clause 1B, wherein generating the respective traverse speed for a blasting device relative the component for each section of the plurality of sections of the surface of the component includes generating the respective traverse speed for a blasting device relative the component within a selected range of traverse speeds for each section of the plurality of sections of the surface of the component.

Clause 4B. The method of clause 1B, wherein generating the respective traverse speed for a blasting device relative the component for each section of a plurality of sections of a surface of the component includes generating a multidimensional array of the respective traverse rates and blasting positions in term of at least an x-position and a y-position corresponding to each position of the plurality of sections.

Clause 5B. The method of clause 1B, further comprising, prior to blasting the component, comparing the respective traverse speeds generated for each section of a plurality of sections of a surface of the component to a spatial resolution defined by a plume of the blasting device and movement capabilities of the blasting device.

Clause 6B. The method of clause 1B, wherein generating, by the computing device and based on the comparison, the respective traverse speed for the blasting device relative the component for each section of the plurality of sections of the surface of the component includes iteratively generating multiple respective traverse speeds for each section of the plurality of sections and selecting one of the multiple respective traverse speeds based on a number of passes and local velocities that minimizes a predicted variation from the target geometry for the blasted component.

Clause 7B. The method of clause 1B, wherein controlling, by the computing device, the abrasive blasting device to abrasively blast the component according to the respective traverse speeds relative the component generated for the plurality of sections of the surface of the component to remove material from the surface of the component results in an intermediate geometry for the blasted component, the method further comprising: comparing, by the computing device, the intermediate geometry for the blasted component to the target geometry for the blasted component; generating, by the computing device and based on the comparison, a respective traverse speed for a blasting device relative the blasted component for each section of a plurality of sections of a surface of the blasted component; and controlling, by the computing device, the abrasive blasting device to abrasively blast the blasted component according to the respective traverse speeds relative the component generated for the plurality of sections of a surface of the component to remove material from the surface of the component.

Clause 8B. The method of clause 1B, further comprising generating, based on the comparison, a respective plume size for each section of a plurality of sections of a surface of the component, and wherein controlling, by the computing device, the abrasive blasting device to abrasively blast the component according to the respective traverse speeds includes controlling, by the computing device, the abrasive blasting device to abrasively blast the component according to the respective traverse speeds and the respective plume sizes.

Clause 9B. The method of clause 1B, wherein the respective plume sizes are generated to provide for the blasted component to have a geometry with a threshold variation of the target geometry with only a single pass of the plume of the surface of the component.

Clause 10B. The method of clause 1B, wherein the blasted component has a surface roughness of at least about 1.5 microns following the abrasive blasting.

Clause 11B. The method of clause 1B, further comprising forming a coating on the blasted component following the abrasive blasting, the coating comprising at least one of a bond layer, an environmental barrier coating or a thermal barrier coating.

Clause 12B. The method of clause 11B, further comprising preheating the roughened component prior to the formation of the coating on the roughened component.

Clause 13B. The method of clause 12B, further comprising identifying the respective traverse speeds for the blasting process and a heating temperature for the heating step from a plurality of sets of values based on a predicted level of material removal, adhesion and cost predicted for each set of values of the plurality of sets of values.

Clause 14B. An abrasive blasting system comprising: an abrasive blasting device configured to deliver an abrasive material to a surface of a component to blast a surface of the component with the abrasive material, wherein the component comprises a metallic, a ceramic or ceramic matrix composite component; and a computing device, wherein the computing device is configured to: compare a geometry for a component to a target geometry for a blasted component, wherein the component comprises a metallic, a ceramic or ceramic matrix composite component; generating, based on the comparison, a respective traverse speed for a blasting device relative the component for each section of a plurality of sections of a surface of the component; and controlling the abrasive blasting device to abrasively blast the component according to the respective traverse speeds relative the component generated for the plurality of sections of the surface of the component to remove material from the surface of the component.

Clause 15B. The system of clause 14B, wherein the computing device is configured to determine a target material removal for each section of the plurality of sections based on the comparison, and generate, based on the target material removal at each section for the plurality of sections, the respective traverse speed for the blasting device relative the component for each section of the plurality of sections of the surface of the component.

Clause 16B. The system of clause 14B, wherein the computing device is configured to generate the respective traverse speed for a blasting device relative the component within a selected range of traverse speeds for each section of the plurality of sections of the surface of the component.

Clause 17B. The system of clause 14B, wherein the computing device is configured to generate a multidimensional array of the respective traverse rates and blasting positions in term of at least an x-position and a y-position corresponding to each position of the plurality of sections.

Clause 18B. The system of clause 14B, wherein the computing device is configured to, prior to blasting the component, compare the respective traverse speeds generated for each section of a plurality of sections of a surface of the component to a spatial resolution defined by a plume of the blasting device and movement capabilities of the blasting device.

Clause 19B. The system of clause 14B, wherein the computing device is configured to iteratively generating multiple respective traverse speeds for each section of the plurality of sections and select one of the multiple respective traverse speeds based on a number of passes and local velocities that minimizes a predicted variation from the target geometry for the blasted component.

Clause 20B. The system of clause 14B, wherein controlling, by the computing device, the abrasive blasting device to abrasively blast the component according to the respective traverse speeds results in an intermediate geometry for the blasted component, wherein the computing device is configured to: compare the intermediate geometry for the blasted component to the target geometry for the blasted component; generating, based on the comparison, a respective traverse speed for a blasting device relative the blasted component for each section of a plurality of sections of a surface of the blasted component; and control the abrasive blasting device to abrasively blast the blasted component according to the respective traverse speeds relative the component generated for the plurality of sections of a surface of the component to remove material from the surface of the component.

Clause 21B. The system of clause 14B, wherein the computing device is configured to generate, based on the comparison, a respective plume size for each section of a plurality of sections of a surface of the component, and control the abrasive blasting device to abrasively blast the component according to the respective traverse speeds and the respective plume sizes.

Clause 22B. The system of clause 14B, wherein the respective plume sizes are generated to provide for the blasted component to have a geometry with a threshold variation of the target geometry with only a single pass of the plume of the surface of the component.

Clause 23B. The system of clause 14B, further comprising a thermal spray device configured to form a coating on the blasted component following the abrasive blasting, the coating comprising at least one of a bond layer, an environmental barrier coating or a thermal barrier coating.

Clause 24B. The system of clause 23B, wherein the thermal spray device is configured to preheat the roughened component prior to the formation of the coating on the roughened component.

Clause 25B. The system of clause 24B, wherein the computing device is configured to identify the respective traverse speeds for the blasting process and a heating temperature for the preheating step from a plurality of sets of values based on a predicted level of material removal, adhesion and cost predicted for each set of values of the plurality of sets of values.

What is claimed is:

1. A method comprising:
comparing, by a computing device, a geometry for a component to a target geometry for a blasted component, wherein the component comprises a metallic, a ceramic or ceramic matrix composite component;
generating, by the computing device and based on the comparison, a respective traverse speed for a blasting device relative the component for each section of a plurality of sections of a surface of the component; and
controlling, by the computing device, an abrasive blasting device to abrasively blast the component according to the respective traverse speeds relative the component generated for the plurality of sections of the surface of the component to remove material from the surface of the component.

2. The method of claim 1, further comprising determining a target material removal for each section of the plurality of sections based on the comparison, wherein generating the respective traverse speed for the blasting device relative the component for each section of the plurality of sections of the surface of the component includes generating, based on the target material removal at each section for the plurality of sections, the respective traverse speed for the blasting device relative the component for each section of the plurality of sections of the surface of the component.

3. The method of claim 1, wherein generating the respective traverse speed for a blasting device relative the component for each section of the plurality of sections of the surface of the component includes generating the respective traverse speed for a blasting device relative the component within a selected range of traverse speeds for each section of the plurality of sections of the surface of the component.

4. The method of claim 1, wherein generating the respective traverse speed for a blasting device relative the component for each section of a plurality of sections of a surface of the component includes generating a multidimensional array of the respective traverse rates and blasting positions in term of at least an x-position and a y-position corresponding to each position of the plurality of sections.

5. The method of claim 1, further comprising, prior to blasting the component, comparing the respective traverse speeds generated for each section of a plurality of sections of a surface of the component to a spatial resolution defined by a plume of the blasting device and movement capabilities of the blasting device.

6. The method of claim 1, wherein generating, by the computing device and based on the comparison, the respective traverse speed for the blasting device relative the component for each section of the plurality of sections of the surface of the component includes iteratively generating multiple respective traverse speeds for each section of the plurality of sections and selecting one of the multiple respective traverse speeds based on a number of passes and local velocities that minimizes a predicted variation from the target geometry for the blasted component.

7. The method of claim 1, wherein controlling, by the computing device, the abrasive blasting device to abrasively blast the component according to the respective traverse speeds relative the component generated for the plurality of sections of the surface of the component to remove material from the surface of the component results in an intermediate geometry for the blasted component, the method further comprising:
comparing, by the computing device, the intermediate geometry for the blasted component to the target geometry for the blasted component;
generating, by the computing device and based on the comparison, a respective traverse speed for a blasting device relative the blasted component for each section of a plurality of sections of a surface of the blasted component; and
controlling, by the computing device, the abrasive blasting device to abrasively blast the blasted component according to the respective traverse speeds relative the component generated for the plurality of sections of a surface of the component to remove material from the surface of the component.

8. The method of claim 1, further comprising generating, based on the comparison, a respective plume size for each section of a plurality of sections of a surface of the component, and wherein controlling, by the computing device, the abrasive blasting device to abrasively blast the component according to the respective traverse speeds includes controlling, by the computing device, the abrasive blasting device to abrasively blast the component according to the respective traverse speeds and the respective plume sizes.

9. The method of claim 1, wherein the respective plume sizes are generated to provide for the blasted component to have a geometry with a threshold variation of the target geometry with only a single pass of the plume of the surface of the component.

10. The method of claim 1, wherein the blasted component has a surface roughness of at least about 1.5 microns following the abrasive blasting.

11. The method of claim 1, further comprising forming a coating on the blasted component following the abrasive blasting, the coating comprising at least one of a bond layer, an environmental barrier coating or a thermal barrier coating.

12. The method of claim 11, further comprising preheating the roughened component prior to the formation of the coating on the roughened component.

13. The method of claim 12, further comprising identifying the respective traverse speeds for the blasting process and a heating temperature for the heating step from a plurality of sets of values based on a predicted level of material removal, adhesion and cost predicted for each set of values of the plurality of sets of values.

14. An abrasive blasting system comprising:
an abrasive blasting device configured to deliver an abrasive material to a surface of a component to blast a surface of the component with the abrasive material, wherein the component comprises a metallic, a ceramic or ceramic matrix composite component; and
a computing device, wherein the computing device is configured to:
compare a geometry for a component to a target geometry for a blasted component, wherein the component comprises a metallic, a ceramic or ceramic matrix composite component;
generating, based on the comparison, a respective traverse speed for a blasting device relative the component for each section of a plurality of sections of a surface of the component; and
controlling the abrasive blasting device to abrasively blast the component according to the respective traverse speeds relative the component generated for the plurality of sections of the surface of the component to remove material from the surface of the component.

15. The system of claim 14, wherein the computing device is configured to determine a target material removal for each section of the plurality of sections based on the comparison, and generate, based on the target material removal at each section for the plurality of sections, the respective traverse speed for the blasting device relative the component for each section of the plurality of sections of the surface of the component.

16. The system of claim 14, wherein the computing device is configured to generate the respective traverse speed for a blasting device relative the component within a selected range of traverse speeds for each section of the plurality of sections of the surface of the component.

17. The system of claim 14, wherein the computing device is configured to generate a multidimensional array of the respective traverse rates and blasting positions in term of at least an x-position and a y-position corresponding to each position of the plurality of sections.

18. The system of claim 14, wherein the computing device is configured to, prior to blasting the component, compare the respective traverse speeds generated for each section of a plurality of sections of a surface of the component to a spatial resolution defined by a plume of the blasting device and movement capabilities of the blasting device.

19. The system of claim 14, wherein the computing device is configured to iteratively generating multiple respective traverse speeds for each section of the plurality of sections and select one of the multiple respective traverse speeds based on a number of passes and local velocities that minimizes a predicted variation from the target geometry for the blasted component.

20. A method comprising:
comparing, by a computing device, a geometry for a component to a target geometry for a blasted component, wherein the component comprises a metallic, a ceramic or ceramic matrix composite component;
generating, by the computing device and based on the comparison, an abrasive blasting path over a surface of the component for a selected traverse speed; and
controlling, by the computing device, an abrasive blasting device to abrasively blast the component with the generated abrasive blasting path to remove material from the surface of the component.
